(19) United States
(12) Patent Application Publication
(10) Pub. No.: US 2026/0189265 A1
(43) Pub. Date: Jul. 2, 2026

(54) GUARD INTERVAL COORDINATION FOR MULTI-ACCESS POINT COMMUNICATION

(71) Applicant: Ofinno, LLC, Reston, VA (US)

(72) Inventors: Jiayi Zhang, Rockville, MD (US); Leonardo Alisasis Lanante, Reston, VA (US); Esmael Hejazi Dinan, McLean, VA (US); Jeongki Kim, Fairfax, VA (US)

(73) Assignee: Ofinno, LLC, Reston, VA (US)

(21) Appl. No.: 19/546,491

(22) Filed: Feb. 23, 2026

Related U.S. Application Data
(63) Continuation of application No. PCT/US2024/044305, filed on Aug. 29, 2024.
(60) Provisional application No. 63/535,325, filed on Aug. 30, 2023.

(51) Int. Cl. H04B 7/024

(52) U.S. Cl. CPC H04B 7/024

(57) ABSTRACT

In an aspect, a first access point (AP) receives from a second AP a first frame indicating a first guard interval for a transmission from the second AP to a station (STA). The transmission is scheduled during a transmission opportunity (TXOP) of the first AP. The first AP transmits to the second AP a second frame indicating a second guard interval for the transmission. The second guard interval is based on the first guard interval. In another aspect the first AP transmits to the second AP a first frame indicating a first guard interval. The first AP receives from the second AP a second frame indicating a second guard interval.

### CROSS-REFERENCE TO RELATED APPLICATIONS

This application is a continuation of International Application No. PCT/US2024/044305, filed Aug. 29, 2024, which claims the benefit of U.S. Provisional Application No. 63/535,325, filed Aug. 30, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example Medium Access Control (MAC) frame format.

FIG. 4 illustrates an example management frame which may be used as an action frame.

FIG. 5 illustrates an example control frame which may be used as a trigger frame.

FIG. 6 illustrates an example data frame which may be used as a Quality of Service (QoS) null frame.

FIG. 7 illustrates an example format of a physical layer (PHY) protocol data unit (PPDU).

FIG. 8 illustrates an example multi-AP network.

FIG. 9 illustrates an example network that includes a coordinated AP set.

FIG. 10 illustrates an example multi-AP operation procedure.

FIG. 11 illustrates an example multi-AP sounding phase.

FIG. 12 illustrates an example multi-AP downlink data transmission phase.

FIG. 13 illustrates an example multi-AP uplink data transmission phase.

FIG. 14 illustrates another example format of a PPDU.

FIG. 15 is an example that illustrates an existing multi-AP transmission procedure according to an embodiment.

FIG. 16 is an example that illustrates a guard interval (GI) coordination procedure for multi-AP communication according to an embodiment.

FIG. 17 is an example that illustrates a GI coordination procedure for multi-AP communication according to an embodiment.

FIG. 18 is an example that illustrates a GI coordination procedure for multi-AP communication according to an embodiment.

FIG. 19 is an example that illustrates a GI coordination procedure for multi-AP communication according to an embodiment.

FIG. 20 illustrates an example action frame which may be used according to embodiments.

FIG. 21 illustrates an example QoS null frame which may be used according to embodiments.

FIG. 22 illustrates an example process according to an embodiment of the present disclosure.

FIG. 23 illustrates an example process according to an embodiment of the present disclosure.

FIG. 24 illustrates an example process according to an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B ={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

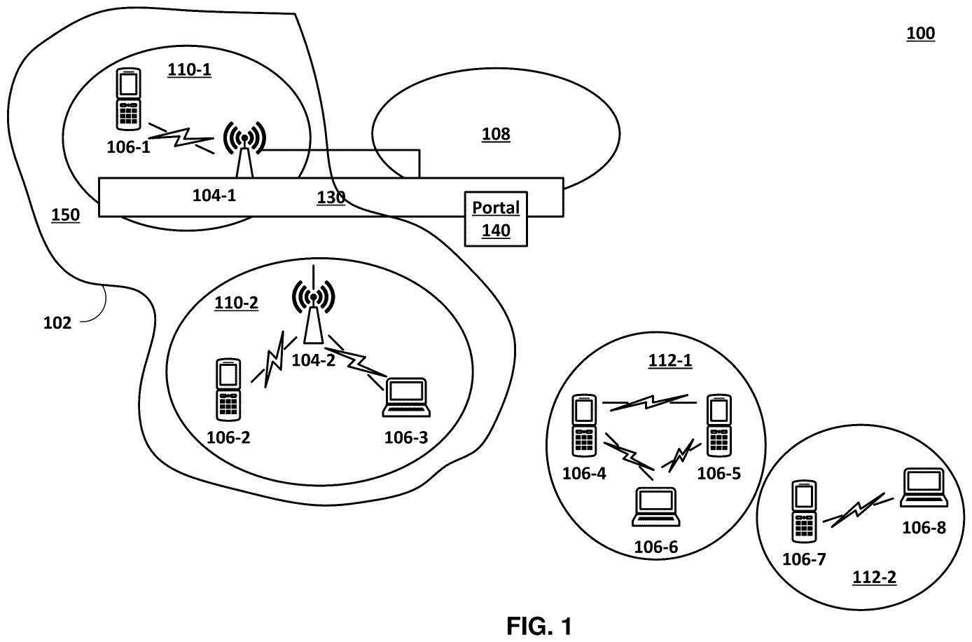

FIG. 1 illustrates example wireless communication networks 100 in which embodiments of the present disclosure may be implemented.

As shown in FIG. 1, the example wireless communication networks 100 may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STA 106-2 and STA 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, AP 104-1 and AP 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STA 106-4, STA 106-5, and 106-6 may be configured to form a first IBSS 112-1. Similarly, STA 106-7 and STA 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 1120 MHz by bonding together multiple 20 MHz channels.

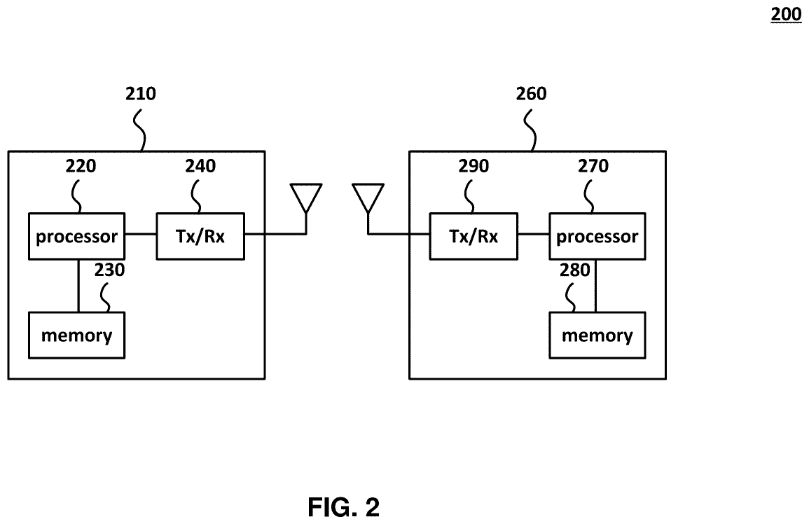

FIG. 2 is a block diagram 200 illustrating example implementations of a STA 210 and an AP 260. As shown in FIG. 2, STA 210 may include at least one processor 220, a memory 230, and at least one transceiver 240. AP 260 may include at least one processor 270, memory 280, and at least one transceiver 290. Processor 220/270 may be operatively connected to transceiver 240/290.

Transceiver 240/290 may be configured to transmit/receive radio signals. In an embodiment, transceiver 240/290 may implement a PHY layer of the corresponding device (STA 210 or AP 260).

In an embodiment, STA 210 and/or AP 260 may be a multi-link device (MLD), that is a device capable of operating over multiple links as defined by the IEEE 802.11be standard amendment. As such, STA 210 and/or AP 260 may each have multiple PHY layers. The multiple PHY layers may be implemented using one or more of transceivers 240/290.

Processor 220/270 may implement functions of the PHY layer, the MAC layer, and/or the logical link control (LLC) layer of the corresponding device (STA 210 or AP 260).

Processor 220/270 and/or transceiver 240/290 may include application specific integrated circuit (ASIC), other chipset, logic circuit and/or data processor. Memory 230/280 may include read-only memory (ROM), random access memory (RAM), flash memory, memory card, storage medium and/or other storage unit.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

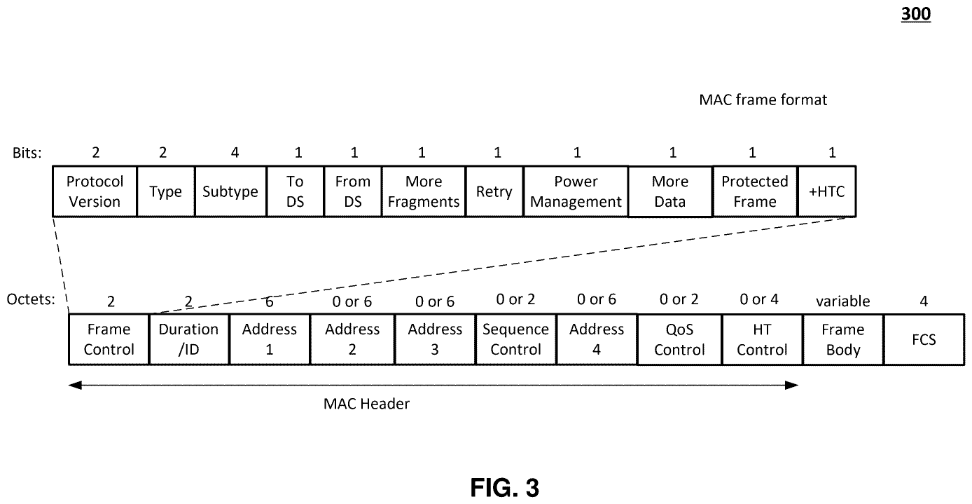

FIG. 3 illustrates an example format of a MAC frame 300. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, MAC frame 300 includes a MAC header, a variable length frame body, and a frame check sequence (FCS).

The MAC header includes a frame control field, an optional duration/ID field (not in PS-Poll frames), address fields, an optional sequence control field, an optional QoS control field (only in QoS Data frames), and an optional high throughput (HT) control field (only in +HTC frames).

The frame control field includes the following subfields: protocol version, type, subtype, To DS, From DS, more fragments, retry, power management, more data, protected frame, and high throughput control (+HTC).

The protocol version subfield is invariant in size and placement across all revisions of the IEEE 802.11 standard. The value of the protocol version subfield is 0 for MAC frames.

The type and subtype subfields together identify the function of the MAC frame. There are three frame types:
control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contains no frame body field.

The To DS subfield indicates whether a data frame is destined to the DS. The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (BUs) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that MAC frame 300 contains an HT control field. A frame that contains the HT Control field is referred to as a +HTC frame. A Control Wrapper frame is a +HTC frame.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that indicates to a STA an amount of time during which it must defer from accessing the shared medium.

There can be up to four address fields in the format of MAC frame 300. These fields are used to indicate the basic service set identifier (BSSID), source address (SA), destination address (DA), transmitter address (TA), and receiver address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which MAC frame 300 belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field. The control frame subtype for which HT control field is present is the control wrapper frame. A control frame that is described as +HTC (e.g., a request to send (RTS)+HTC, clear to send (CTS)+HTC, block acknowledgment (BlockAck)+HTC or block acknowledgment request (BlockAckReq)+HTC frame) implies the use of the control wrapper frame to carry that control frame.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

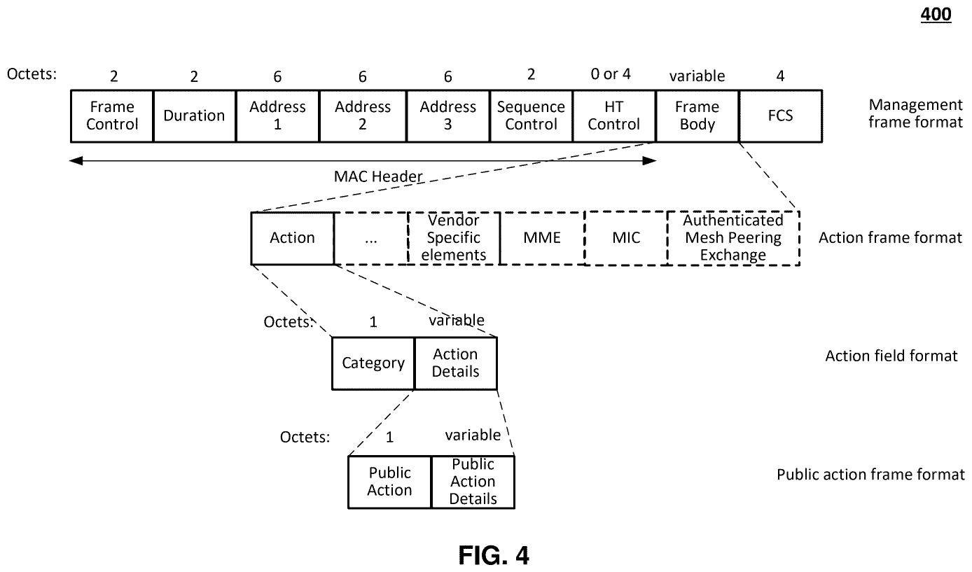

FIG. 4 illustrates an example management frame 400 which may be used as an action frame. In example, management frame 400 includes a MAC header, a variable length frame body, and a frame check sequence (FCS). The MAC header includes a frame control field, a duration field, an address 1 field, an address 2 field, an address 3 field, a sequence control field, and an optional HT control field. The presence of the HT control field is determined by the setting of a +HTC subfield of the frame control field.

As shown in FIG. 4, when used as an action frame, the frame body of management frame includes an action field, vendor specific elements, management message integrity code element (MME), message integrity code (MIC), and an authenticated mesh peering exchange element.

The action field includes a category field and an action details field. The action field provides a mechanism for specifying extended management actions. The category field indicates a category of the action frame. The action details field contains the details of the action requested by the action frame. For example, the action frame may be a public action frame. As shown in FIG. 4, in the public action frame format, the action details field includes a public action field, in the octet immediately after the category field, followed by a variable length public action details field.

One or more vendor specific elements are optionally present. These elements are absent when the category subfield of the Action field is vendor-specific.

The MME is present when management frame protection is negotiated, the frame is a group addressed robust Action frame, and (MBSS only) the category of the action frame does not support group addressed privacy as indicated by category values; otherwise not present.

The MIC element is present in a self-protected action frame if a shared pairwise master key (PMK) exists between the sender and recipient of this frame; otherwise not present.

The authenticated mesh peering exchange element is present in a self-protected action frame if a shared PMK exists between the sender and recipient of this frame; otherwise not present.

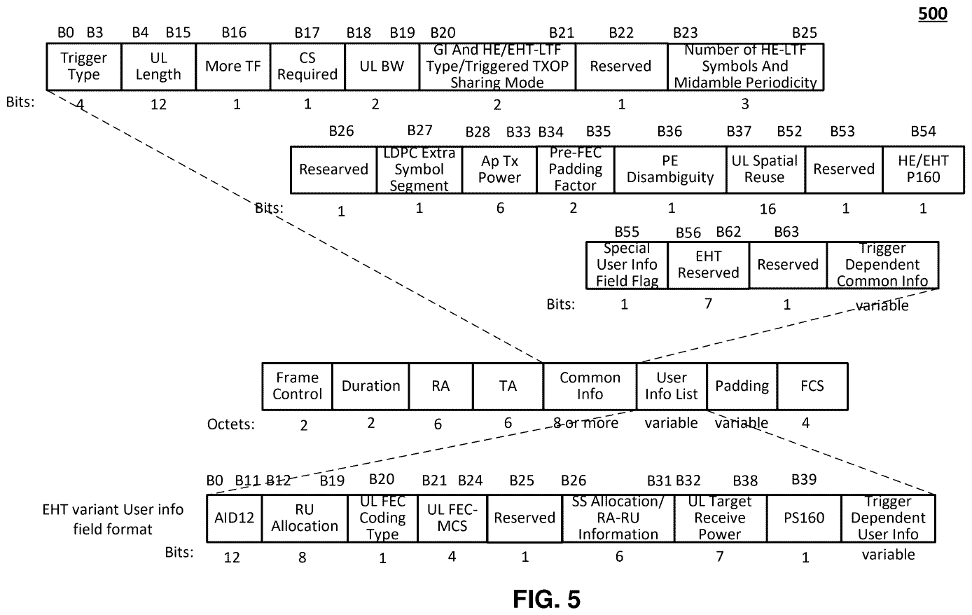

FIG. 5 illustrates an example format of a trigger frame 500. Trigger frame 500 may be used by an AP to allocate resources for and solicit one or more TB PPDU transmissions from one or more STAs. Trigger frame 500 may also carry other information required by a responding STA to transmit a TB PPDU to the AP.

As shown in FIG. 5, trigger frame 500 includes a Frame Control field, a Duration field, a receiver address (RA) field, a transmitter address (TA) field, a Common Info field, a User Info List field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 500 if trigger frame 500 is addressed to STAs that belong to a single BSS. The TA field is the transmitted BSSID if trigger frame 500 is addressed to STAs from at least two different BSSs of the multiple BSSID set.

The Common Info field specifies a trigger frame type of trigger frame 500, a transmit power of trigger frame 500 in dBm, and several key parameters of a TB PPDU that is transmitted by a STA in response to trigger frame 500. The trigger frame type of a trigger frame used by an AP to receive QoS data using UL MU operation is referred to as a basic trigger frame. A non-EHT non-AP HE STA interprets the Common Info field as HE variant. A non-AP EHT STA interprets the Common Info field as HE variant if B54 and B55 in the Common Info field are equal to 1; and interprets the Common Info field as EHT variant otherwise. The HE variant Common Info field and the EHT variant Common Info field use the same encoding method for the Trigger Type, UL Length, More TF, CS Required, LDPC Extra Symbol Segment, AP TX Power, Pre-FEC Padding Factor, PE Disambiguity, and Trigger Dependent Common Info subfields.

The User Info List field contains zero or more User Info fields. There are three variants for the User Info field, which are the Special User Info field, the EHT variant User Info field, and the HE variant User Info field.

The Special User Info field is a User Info field that does not carry the user specific information but carries the extended common information not provided in the Common Info field. If the Special User Info field is included in the Trigger frame, then the Special User Info Field Flag subfield of the EHT variant Common Info field is set to 0, otherwise it is set to 1. The Special User Info field is identified by an AID 12 value of 2007 and is optionally present in a Trigger frame that is generated by an EHT AP. The Special User Info field, if present, is located immediately after the Common Info field of the Trigger frame and carries information for the U-SIG field of a solicited EHT TB PPDU. The PHY Version Identifier subfield indicates the PHY version of the solicited TB PPDU that is not an HE TB PPDU. The PHY Version Identifier subfield is set to 0 for EHT. Other values from 1 to 7 are reserved. The UL Bandwidth (BW) Extension subfield, together with the UL BW subfield in the Common Info field, indicates the bandwidth of the solicited TB PPDU from the addressed EHT STA (i.e., the bandwidth in the U-SIG field of the EHT TB PPDU). The EHT Spatial Reuse n subfield carries the values to be included in the corresponding Spatial Reuse n subfield in the U-SIG field of the EHT TB PPDU. The U-SIG Disregard And Validate subfield carries the values to be included in the Disregard and Validate subfields of the U-SIG field of the solicited EHT TB PPDUs. The presence and length of the Trigger Dependent User Info subfield in the Special User Info field depends on the variant of the Trigger frame.

The EHT variant User Info field contains a User Info field per STA addressed in trigger frame 500. The per STA User Info field includes, among others, an AID12 subfield, an RU Allocation subfield, a UL FEC Coding Type subfield, a UL EHT-MCS subfield, a Reserved subfield, a Spatial Stream (SS) Allocation/RA-RU information subfield, a UL Target Receive Power subfield, and a Power Save (PS) 160 subfield to be used by a STA in a TB PPDU transmitted in response to trigger frame 500, and a Trigger Dependent User Info subfield. The RU Allocation subfield in an EHT variant User Info field in a Trigger frame that is not an MU-RTS Trigger frame, along with the UL BW subfield in the Common Info field, the UL BW Extension subfield in the Special User Info field, and the PS160 subfield in the EHT variant User Info field, identifies the size and the location of the RU or MRU. The values of PS160 subfield and B0 of RU Allocation subfield indicate the 80 MHz frequency subblock in which the RU or MRU is located for 26-tone RU, 52-tone RU, 106-tone RU, 242-tone RU, 484-tone RU, 996-tone RU, 52+26-tone RU, and 106+26-tone RU. The values of PS 160 subfield indicates the 160 MHz segment in which the RU or MRU is located for 2+996-tone RU, 996+484-tone MRU, and 996+484+242-tone MRU. The UL FEC Coding Type subfield of the User Info field indicates the code type of the solicited EHT TB PPDU. The UL FEC Coding Type subfield is set to 0 to indicate BCC and set to 1 to indicate LDPC. The UL EHT-MCS subfield of the User Info field indicates the EHT-MCS of the solicited EHT TB PPDU. The SS Allocation subfield of the EHT variant User Info field indicates the spatial streams of the solicited EHT TB PPDU. The UL Target Receive Power subfield indicates the expected receive signal power, measured at the AP's antenna connector and averaged over the antennas, for the EHT portion of the EHT TB PPDU transmitted on the assigned RU. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA. The RA-RU Information subfield is reserved in the EHT variant User Info field.

The Padding field is optionally present in trigger frame 400 to extend the frame length to give recipient STAs enough time to prepare a response for transmission one SIFS after the frame is received. The Padding field, if present, is at least two octets in length and is set to all 1 s.

The FCS field is used by a STA to validate a received frame and to interpret certain fields from the MAC headers of a frame.

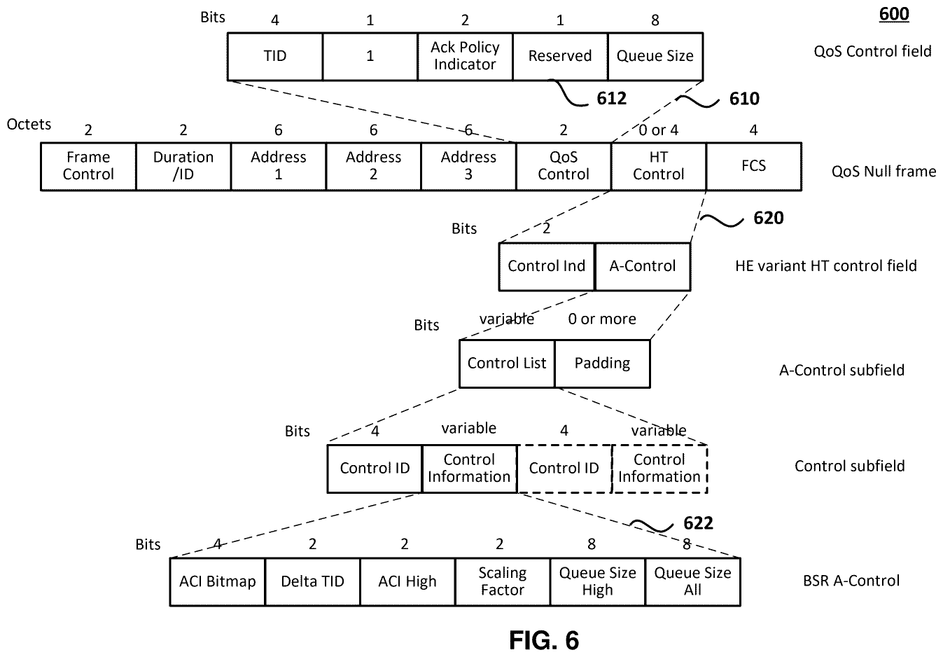

FIG. 6 illustrates an example data frame 600 which may be used as a QoS null frame. A QoS null frame refers to a QoS data frame with an empty frame body. QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an acknowledgment (Ack) policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the Ack policy followed upon delivery of the MPDU (e.g., normal Ack, implicit block Ack request, no Ack, block Ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine the TXOP duration assigned to the STA or to determine the uplink (UL) resources assigned to the STA.

In a frame sent by or to a non-high efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
   16×UV, if SF is equal to 0;
   1024+256×UV, if SF is equal to 1;
   17 408+2048×UV, if SF is equal to 2;
   148 480+32 768×UV, if SF is equal to 3 and UV is less than 62;
   >2 147 328, if SF equal to is 3 and UV is equal to 62;
   Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include an aggregated control (A-Control) subfield. The A-Control subfield may include a control list subfield including one or more control subfields.

The control subfield may be a BSR control subfield, which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

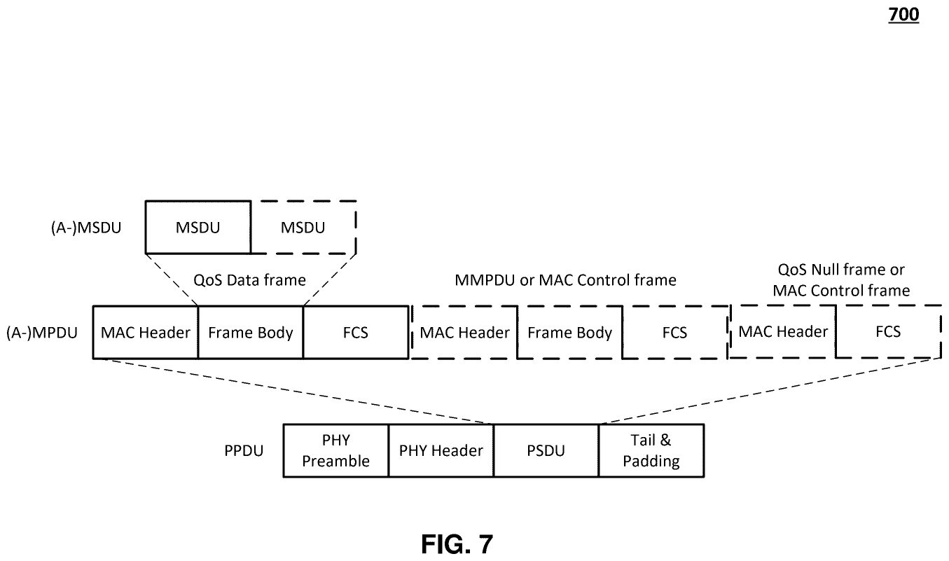

FIG. 7 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in an UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

A multi-link device (MLD) is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both the communicating AP MLD and non-AP MLD.

an MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de)authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

In a multi-link (re)setup procedure, a non-AP MLD may initiate a TID-to-link mapping negotiation by including a TID-to-link mapping element in a (re)association request frame if an AP MLD has indicated support for TID-to-link mapping negotiation. After receiving the (re)association request frame containing the TID-to-link mapping element, the AP MLD may reply to the (re)association request frame according to the following rules. The AP MLD can accept the requested TID-to-link mapping indicated in the TID-to-link mapping element in the received (re)association request frame only if it accepts the multi-link (re)setup for all links on which at least one TID is requested to be mapped. In this case, the non-AP MLD does include in the (re)association response frame a TID-to-link mapping element. Otherwise, the non-AP MLD indicates rejection of the proposed TID-to-link mapping by including in the (re)association response frame a TID-to-link mapping element that suggests a preferred TID-to-link mapping.

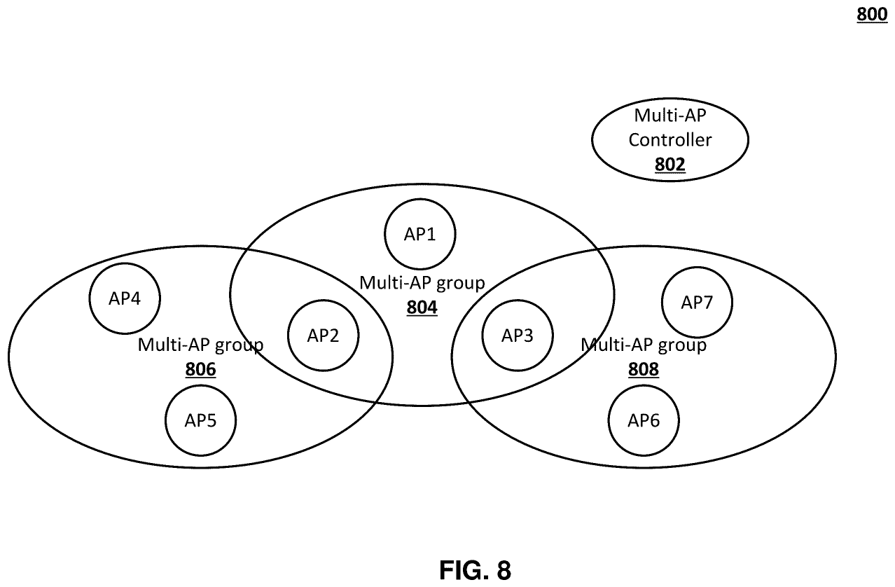

FIG. 8 illustrates an example multi-AP network 800. Example multi-AP network 800 may be a multi-AP network in accordance with the Wi-Fi Alliance standard specification for multi-AP networks. As shown in FIG. 8, multi-AP network 800 may include a multi-AP controller 802 and a plurality of multi-AP groups (or multi-AP sets, or AP candidate sets), including multi-AP group 804, multi-AP group 806, and multi-AP group 808.

Multi-AP controller 802 may be a logical entity that implements logic for controlling the APs in multi-AP network 800. Multi-AP controller 802 may receive capability information and measurements from the APs and may trigger AP control commands and operations on the APs. Multi-AP controller 802 may also provide onboarding functionality to onboard and provision APs onto multi-AP network 800.

Multi-AP group 804, multi-AP group 806, and multi-AP group 808 may each include a plurality of APs. APs in a multi-AP group are in communication range of each other. However, the APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, one of the APs in a multi-AP group may be designated as a master AP. The designation of the master AP may be done by multi-AP controller 802 or by the APs of the multi-AP group. The master AP of a multi-AP group may be fixed or may change over time between the APs of the multi-AP group. An AP that is not the master AP of the multi-AP group is known as a slave AP.

In one approach, a multi-AP group or an AP candidate set is a set of APs that can initiate or participate in multi-AP coordination. An AP in a multi-AP group can participate as a slave AP in multi-AP coordination initiated by a master AP in the same multi-AP group. At least one AP in a multi-AP group shall be capable of being a master AP.

In one approach, APs in a multi-AP group may coordinate with each other, including coordinating transmissions within the multi-AP group. One aspect of coordination may include coordination to perform multi-AP transmissions within the multi-AP group. As used herein, a multi-AP transmission is a transmission event in which multiple APs (of a multi-AP group or a multi-AP network) transmit simultaneously over a period. The period of simultaneous AP transmission may be a continuous period.

Multi-AP group coordination may be enabled by the multi-AP controller and/or by the master AP of the multi-AP group. In one approach, the multi-AP controller and/or the master AP may control time and/or frequency sharing in a TXOP. For example, when one of the APs (e.g., the master AP) in the multi-AP group obtains a TXOP, the multi-AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Multi-AP operation may be enabled by at least two APs that support multi-AP coordination within one or more multi-AP groups. The APs may support multi-AP transmission schemes in a multi-AP network. A master AP may coordinate with slave AP(s) to enable multi-AP coordination and to support a multi-AP transmission. Slave AP(s) may participate in a multi-AP transmission. The master AP may select the slave AP(s) which are suitable for the multi-AP transmission. Slave APs may be candidates for a multi-AP transmission before being designated by the master AP.

Multi-AP transmission schemes may include transmission schemes such as coordinated OFDMA, coordinated time division multiple access (TDMA), coordinated spatial reuse, coordinated beamforming, joint transmission or reception (JT/JR), or a combination of two or more of the aforementioned schemes.

Coordinated OFDMA and coordinated TDMA may be categorized as coordinated TXOP, in which frequency or time resources of a TXOP may be used to coordinate the interference. Coordinated spatial reuse (CSR) may provide reuse of spatial domain of neighboring BSSs by adjusting the transmit powers of coordinated APs. Coordinated beamforming (CBF) may provide dedicated null steering with spatial radiation based on channel state information (CSI) feedback from coordinated APs with the aid of multiple antennas to suppress the interference. JT/JR may use distributed MIMO precoding or detection, via shared CSI, for data streams among multiple APs.

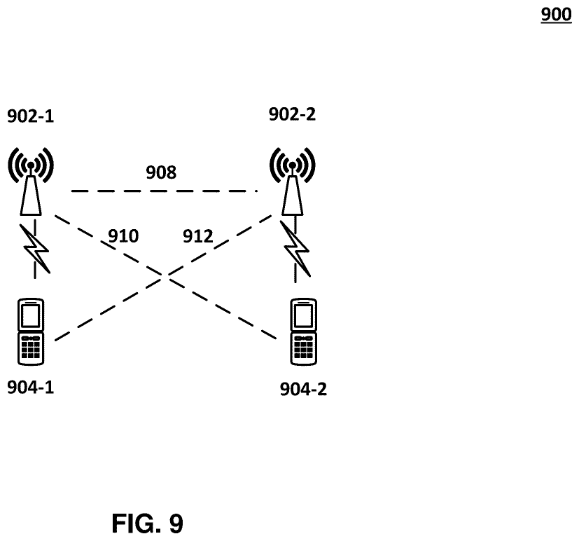

FIG. 9 illustrates an example network 900 that includes a coordinated AP set. As shown in FIG. 9, the coordinated AP set may include AP 902-1 and AP 902-2. The coordinated AP set may be a subset of an established multi-AP group. At least one STA may be associated with each of APs 902-1 and 902-2. For example, a STA 904-1 may be associated with AP 902-1, and a STA 904-2 may be associated with AP 902-2.

APs 902-1 and 902-2 may belong to the same ESS as described above in FIG. 1. In such a case, APs 902-1 and 902-2 may be connected by a DS to support ESS features. In addition, as part of a coordinated AP set, APs 902-1 and 902-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 902-1 and 902-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 9, if AP 902-1 supports JT and CSR while AP 902-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 901-1 and AP 902-2 as shown in FIG. 9. Spatial reuse using CSR can be more stable than non-AP coordinated spatial reuse schemes such as overlapping basic service set (OBSS) packet detect (PD)-based SR and PSR-based SR. For example, in example network 900, APs 902-1 and 902-2 may perform a joint sounding operation in order to measure path loss (PL) on paths of network 900. For example, the joint sounding operation may result in the measurement of PL 908 for the path between APs 902-1 and 902-2, path loss 910 for the path between AP 902-1 and STA 904-2, and path loss 912 for the path between AP 902-2 and STA 904-1. The measured path loss information may then be shared between APs 902-1 and 902-2 (e.g., using the backhaul) to allow for simultaneous transmissions by APs 902-1 and 902-2 to their associated STAs 904-1 and 904-2 respectively. Specifically, one of APs 902-1 and 902-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

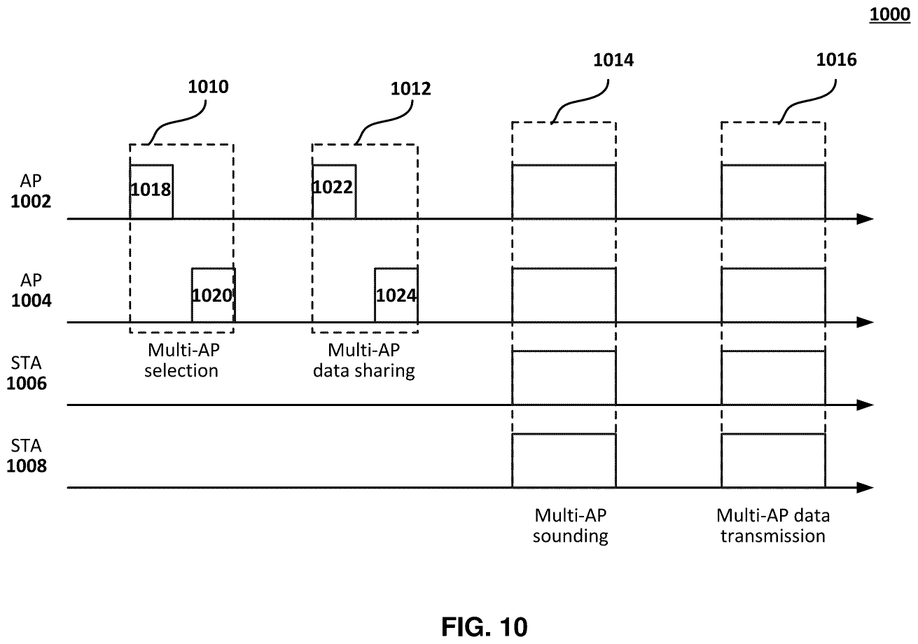

FIG. 10 illustrates an example 1000 of a multi-AP operation procedure. In example 1000, the multi-AP operation procedure is illustrated with respect to a multi-AP network that includes APs 1002 and 1004 and STAs 1006 and 1008. In an example, APs 1002 and 1004 may form a multi-AP group. AP 1002 may be the master AP and AP 1004 may be a slave AP of the multi-AP group. For example, AP 1002 may obtain a TXOP making it the master AP of the multi-AP group. Alternatively, AP 1002 may be designated as the master AP by a multi-AP controller.

As shown in FIG. 10, the multi-AP operation procedure may include a series of phases in time, each of which may contain a plurality of frame exchanges within the multi-AP network. Specifically, the multi-AP operation procedure may include a multi-AP selection phase 1010, a multi-AP data sharing phase 1012, a multi-AP sounding phase 1014, and a multi-AP data transmission phase 1016.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 1010 may include procedures for soliciting, selecting, or designating slave AP(s) for a multi-AP group by a master AP. As seen in FIG. 10, the multi-AP selection phase may include transmissions of frame 1018 from AP 1002 and frame 1020 from AP 1004. AP 1002 may transmit frame 1018 to solicit information regarding the buffer status of AP 1004. In response, AP 1004 may transmit frame 1020 to inform AP 1002 of its and its associated STAs buffer status and/or whether it intends to join multi-AP operation. Multi-AP selection phase 1010 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 1012 may include procedures for sharing data frames to be transmitted by APs to associated STAs among the master AP and selected slave AP(s) via direct connections between APs. Phase 1012 may be optional for some multi-AP data transmission schemes. For example, phase 1012 may be required for JT/JR as data frames may be exchanged between APs before or after multi-AP data transmission phase 1016.

Multi-AP data sharing phase 1012 may be performed using a wired backhaul, an in-channel wireless backhaul, or an off-channel wireless backhaul. In some cases, multi-AP data sharing phase 1012 may be performed over an in-channel backhaul, e.g., using the same wireless channel used to transmit/receive data to/from STAs. For example, as shown in FIG. 10, in phase 1012, AP 1002 may transmit a frame 1022, which may be received by AP 1004. Frame 1022 may include MPDUs that AP 1002 wishes to transmit to associated STAs using a multi-AP operation. Similarly, AP 1004 may transmit a frame 1024, which may be received by AP 1002. Frame 1024 may include MPDUs that AP 1004 wishes to transmit to associated STAs using a multi-AP operation.

Multi-AP sounding phase 1014 may include procedures for multi-AP channel sounding, including channel estimation and feedback of channel estimates among the master AP, candidate slave AP(s), and associated STAs. Phase 1014 may be optional for some multi-AP transmission schemes, such as COFDMA, CDTMA, and CSR. For example, phase 1014 may be performed by the master AP to aid in resource unit allocation when orchestrating a COFDMA transmission.

Multi-AP data transmission phase 1016 may include exchange of data frames between the master AP, slave AP(s), and their associated STAs based on multi-AP transmission scheme(s) determined by the master AP. Depending on the multi-AP transmission scheme(s) to be used, phase 1016 may include optional synchronization between APs of the multi-AP group, before exchange of data frames between APs and STAs within the multi-AP group.

The order of phases 1010, 1012, 1014 and 1016 may be different than shown in FIG. 10. For example, in COFDMA, phase 1016 may occur immediately after phase 1010, whereas, in JT/JR, phase 1012 may occur after phase 1010. Further, as mentioned above, some phases may be optional and may or may not be present. For example, phase 1014 may not be required for COFDMA but may be required for JT/JR.

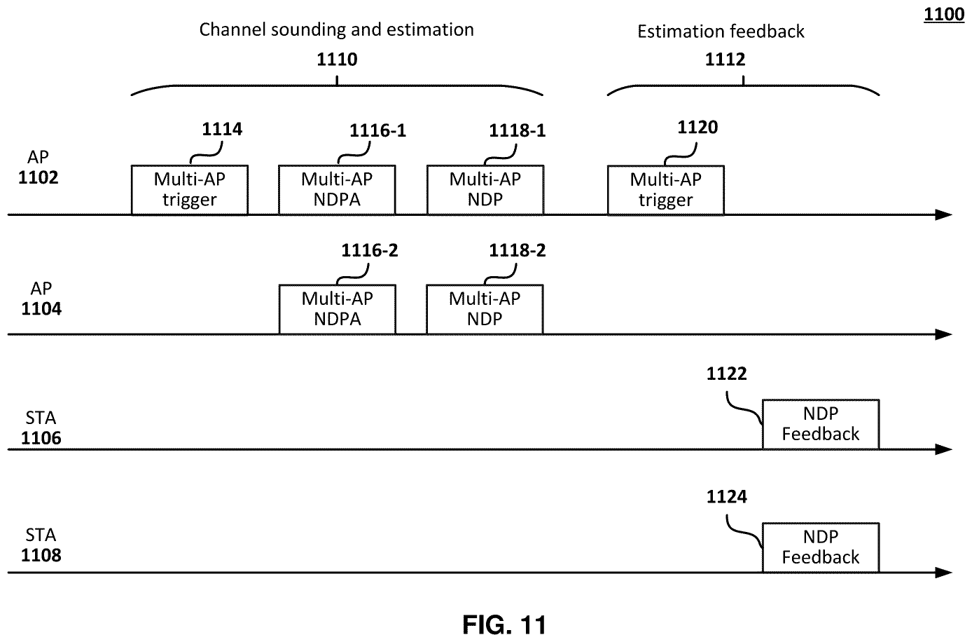

FIG. 11 illustrates an example 1100 of a multi-AP sounding phase. Multi-AP sounding phase 1100 may be an example of multi-AP sounding phase 1014. As shown in FIG. 11, example 1100 may include a master AP 1102 and a slave AP 1104 of a multi-AP group. Example 1100 may further include a STA 1106 associated with AP 1102 and a STA 1108 associated with AP 1104.

As shown in FIG. 11, multi-AP sounding phase 1100 may include frame exchanges to allow AP 1102 (the master AP) to acquire channel state information (CSI) of channels in the multi-AP group. In an implementation, phase 1100 may include a first subphase 1110 and a second subphase 1112.

During the first subphase 1110, APs may initiate channel sounding and STAs may estimate CSI. For example, AP 1102 may transmit a frame 1114 to AP 1104 (the slave AP) to trigger multi-AP sounding. Frame 1114 may comprise a multi-AP trigger frame. Subsequently, APs 1102 and 1104 may transmit respectively announcement frames 1116-1 and 1116-2 to their respective associated STAs 1106 and 1108 to announce the transmission of sounding frames. Frames 1116-1 and 1116-2 may comprise multi-AP null data packet announcement (NDPA) frames. Frames 1116-1 and 1116-2 may be transmitted simultaneously. Next, APs 1102 and 1104 may transmit respectively frames 1118-1 and 1118-2 to STAs 1106 and 1108, respectively. Frames 1118-1 and 1118-2 may comprise multi-AP null data packet (NDP) frames. STAs 1106 and 1108 receive frames 1118-1 and 1118-2 respectively and perform channel estimation of the channels from AP 1102 to STA 1106 and from AP 1104 to STA 1108, respectively.

During the second subphase 1112, APs may initiate a procedure for STAs to feed back channel estimates to the APs. For example, AP 1102 may transmit a frame 1120 to trigger STAs 1106 and 1108 to transmit their channel estimates to APs 1102 and 1104, respectively. Frame 1120 may comprise a multi-AP trigger frame. In response, STAs 1106 and 1108 may transmit respectively frames 1122 and 1124 including feedback of channel estimates to APs 1102 and 1104, respectively. Frames 1122 and 1124 may comprise NDP feedback frames. The feedback of channel estimates may include NDP feedback, CSI-related information, a beamforming report (BFR), or a channel quality indication (CQI) report.

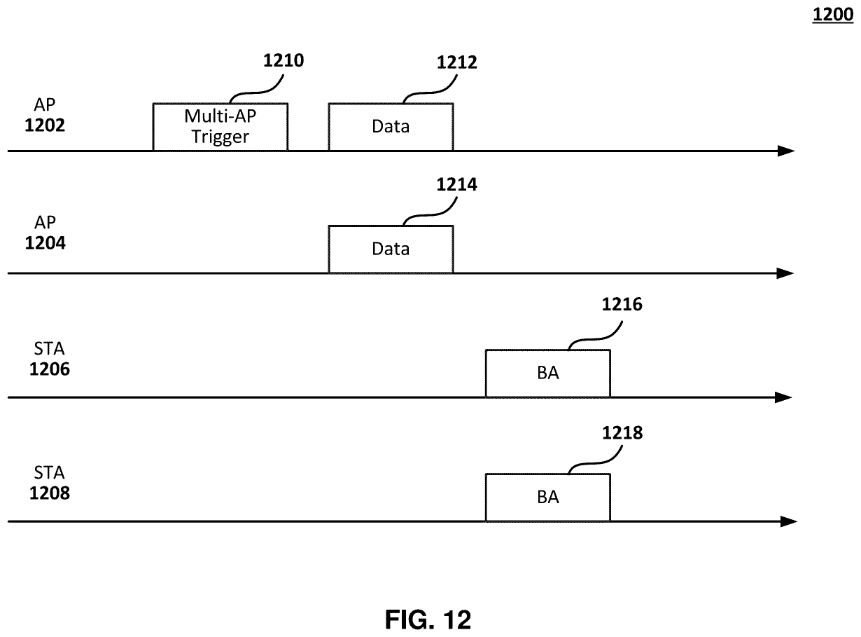

FIG. 12 illustrates an example 1200 of a multi-AP downlink data transmission phase. Multi-AP downlink data transmission phase 1200 may be an example of multi-AP data transmission phase 1016. As shown in FIG. 12, example 1200 may include a master AP 1202 and a slave AP 1204 of a multi-AP group. Example 1200 may further include a STA 1206 associated with AP 1202, and a STA 1208 associated with AP 1204.

As shown in FIG. 12, multi-AP downlink data transmission phase 1200 may include frame exchanges to enable master AP 1202 to coordinate with slave AP 1204 to perform specific multi-AP transmission schemes with their associated STAs 1206 and 1208, respectively. The multi-AP transmission schemes may include COFDMA, CTDMA, CSR, CBF, JT/JR, or a combination of two or more of the aforementioned schemes.

As shown in FIG. 12, master AP 1202 may begin phase 1200 by transmitting a frame 1210 to AP 1204. Frame 1210 may include information related to AP 1204 (e.g., an identifier of AP 1204), synchronization information, information related to a specific multi-AP transmission scheme to be used, and/or information related to a resource unit (RU) for use by AP 1204 to acknowledge frame 1210. Frame 1210 may comprise a control frame. For example, frame 1210 may comprise a multi-AP trigger frame.

Slave AP 1204 may receive frame 1210 and may use the synchronization information to synchronize with master AP 1202. Subsequently, APs 1202 and 1204 may perform data transmission to their associated STAs 1206 and 1208, respectively. Specifically, AP 1202 may transmit a data frame 1212 to its associated STA 1206, and AP 1204 may transmit a data frame 1214 to its associated STA 1208. Depending on the multi-AP transmission scheme being used, APs 1202 and 1204 may transmit frames 1212 and 1214 respectively to STAs in different BSSs. For example, when the multi-AP transmission scheme is JT/JR, AP 1202 may also transmit frame 1212 to STA 1208 associated with slave AP 1204, and AP 1204 may also transmit frame 1214 to STA 1208 associated with AP 1204. The resources for transmitting and receiving frames 1212 and 1214 may depend on the specific multi-AP transmission scheme adopted.

STAs 1206 and 1208 may acknowledge frames 1212 and 1214, respectively. For example, STA 1206 may transmit a frame 1216 to AP 1202, and STA 1208 may transmit a frame 1218 to AP 1204. Frames 1216 and 1218 may comprise block ack (BA) frames. STAs 1206 and 1208 may also transmit frames 1216 and 1218 to APs in different BSSs, when required by the used multi-AP transmission scheme. For example, when the multi-AP transmission scheme is JT/JR, STA 1206 may also transmit frame 1216 to AP 1204, and STA 1208 may also transmit frame 1218 to AP 1202. The resources for transmitting and receiving frames 1216 and 1218 may depend on the specific multi-AP transmission scheme adopted.

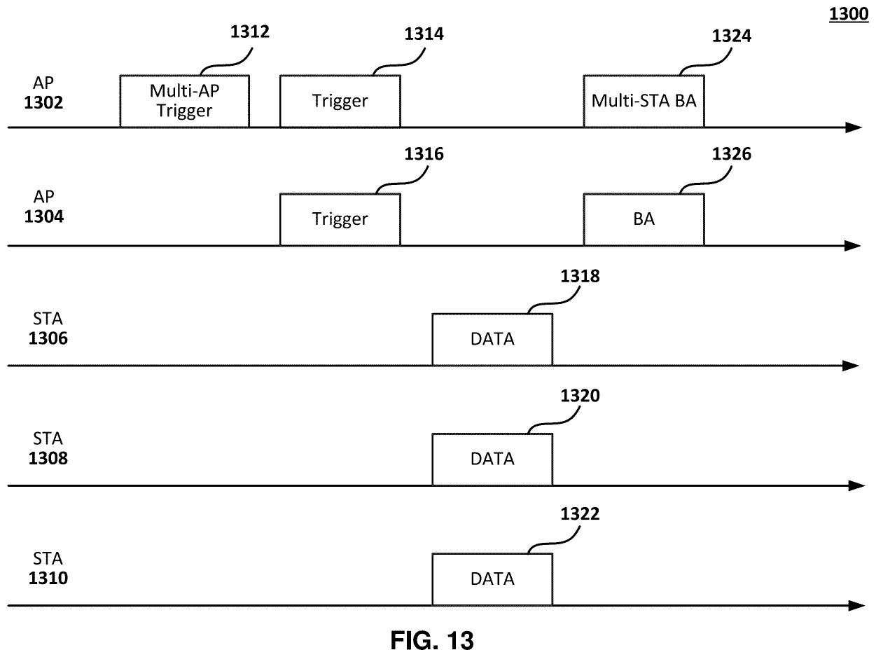

FIG. 13 illustrates an example 1300 of a multi-AP uplink data transmission phase. Multi-AP uplink data transmission phase 1300 may be an example of multi-AP data transmission phase 1016. As shown in FIG. 13, example 1300 may include a master AP 1302 and a slave AP 1304 of a multi-AP group. Example 1300 may further include STAs 1306 and 1308 associated with AP 1302, and a STA 1310 associated with AP 1304.

As shown in FIG. 13, multi-AP uplink data transmission phase 1300 may include frame exchanges to enable master AP 1302 to coordinate with slave AP 1304 to perform specific multi-AP transmission schemes with STAs 1306, 1308, and 1310. The multi-AP transmission schemes may include COFDMA, CTDMA, CSR, CBF, JT/JR, or a combination of two or more of the aforementioned schemes.

As shown in FIG. 13, master AP 1302 may begin phase 1300 by transmitting a frame 1312 to AP 1304. Frame 1312 may include information related to AP 1304 (e.g., an identifier of AP 1304), synchronization information, information related to a specific multi-AP transmission scheme to be used, and/or information related to an RU for use by AP 1304 to acknowledge frame 1312. Frame 1312 may comprise a control frame. For example, frame 1312 may comprise a multi-AP trigger frame.

Slave AP 1304 may receive frame 1312 and may use the synchronization information to synchronize with master AP 1302. Subsequently, APs 1302 and 1304 may solicit uplink data transmissions from their associated STAs 1306, 1308 and 1310 using trigger frames. Specifically, AP 1302 may transmit a trigger frame 1314 to its associated STAs 1306 and 1308, and AP 1304 may transmit a trigger frame 1316 to its associated STA 1310. Depending on the multi-AP transmission scheme being used, APs 1302 and 1304 may also transmit frames 1314 and 1316 respectively to STAs in different BSSs. For example, when the multi-AP transmission scheme is JT/JR, AP 1302 may also transmit frame 1314 to STA 1310 associated with slave AP 1304, and AP 1304 may also transmit frame 1316 to STAs 1306 and 1308 associated with AP 1302. The resources for transmitting and receiving frames 1314 and 1316 may depend on the specific multi-AP transmission scheme adopted.

STAs 1306 and 1308 may respond to frame 1314, STA 1310 may respond to frame 1316. For example, STAs 1306 and 1308 may transmit frames 1318 and 1320 respectively to AP 1302, while STA 1310 may transmit a frame 1322 to AP 1304. Frames 1318, 1320, and/or 1322 may be transmitted simultaneously. Frames 1318, 1320, and 1322 may comprise data frames or null data frames. STAs 1306, 1308, and 1310 may also transmit frames 1318, 1320, and 1322 respectively to APs in different BSSs, when required by the used multi-AP transmission scheme. For example, when the multi-AP transmission scheme is JT/JR, STAs 1306 and 1308 may also transmit respective frames 1318 and 1320 to AP 1304, and STA 1310 may also transmit frame 1322 to AP 1302. The resources for transmitting and receiving frames 1318, 1320, and 1322 may depend on the specific multi-AP transmission scheme adopted.

One function of the MAC sublayer is to transfer MAC service data units (MSDUs) between MAC sublayer entities. The information required for the distribution system service to operate is provided by the association services. Before an MSDU can be handled by the distribution system service, a STA is “associated.”

Three transition types are defined according to the IEEE 802.11 standard:
a) No-transition: In this type, two subclasses that are usually indistinguishable are identified: 1) Static—no motion. 2) Local movement—movement within the PHY range of the communicating STAs, i.e., movement within a basic service area (BSA).
b) BSS-transition: This type is defined as a STA movement from one BSS in one ESS to another BSS within the same ESS. A fast BSS transition is a BSS transition that establishes the state necessary for data connectivity before the reassociation rather than after the reassociation.
c) ESS-transition: This type is defined as STA movement from a BSS in one ESS to a BSS in a different ESS. This case is supported only in the sense that the STA might move.

To deliver an MSDU within an ESS via the DS, the DS needs to know which AP within the ESS to deliver the MSDU, so that the MSDU might ultimately be delivered to the addressed IEEE 802.11 STA. This information is provided to the DS by the concept of association. Association is necessary, but not sufficient, to support BSS-transition mobility. Association is sufficient to support no-transition mobility. Association is one of the services in the DSS.

Before a STA is allowed to send an MSDU via an AP, it first becomes associated with the AP.

At any given instant, a STA is associated with no more than one AP. This allows the DS to determine a unique answer to the question, “Which AP is serving STA X?” Once an association is completed, a STA can make full use of a DS (via the AP) to communicate. Association is always initiated by the non-AP STA, not the AP.

An AP might be associated with many STAs at the same time.

A STA learns what APs are present and what operational capabilities are available from each of those APs and then invokes the association service to establish an association. A FILS STA is able to discover, authenticate and associate with the AP with a reduced number of frame transmissions.

Association is sufficient for no-transition MSDU delivery between IEEE 802.11 STAs. Additional functionality is needed to support BSS-transition mobility. The additional required functionality is provided by the reassociation service. Reassociation is one of the services in the DSS.

The reassociation service is invoked to “move” a current association of a non-AP STA from one AP to another. In an ESS, the reassociation service informs the DS of the current mapping between AP and STA as the STA moves from BSS to BSS within the ESS. Reassociation also enables changing association attributes of an established association while the non-AP STA remains associated with the same AP. Reassociation is always initiated by the non-AP STA.

The disassociation service is invoked when an existing association is to be terminated. Disassociation is one of the services in the DSS.

The disassociation service can be invoked by either party in an association (non-AP STA or AP). Disassociation is a notification, not a request. Disassociation cannot be refused by the receiving STA except when management frame protection is negotiated and the message integrity check fails.

An AP can disassociate STAs to enable the AP to be removed from a network for service or for other reasons.

STAs attempt to disassociate when they leave a network. However, the MAC protocol does not depend on STAs invoking the disassociation service. (MAC management is designed to accommodate loss of communication with an associated STA.)

In an example, the PHY layer of WLAN devices (e.g., STA 210 or AP 290) may implement an extremely high throughput (EHT) orthogonal frequency division multiplexing (OFDM) system. The EHT-OFDM system provides a WLAN with data payload communication capabilities.

Inter-symbol interference (ISI) between OFDM symbols that are adjacent in time degrades the orthogonality between the subcarriers and impairs performance. ISI may be caused by delay spread in the channel and filtering. To minimize the impact of ISI, a guard interval (GI) is added between adjacent OFDM symbols.

In an implementation, a cyclic prefix (CP) of an OFDM symbol may be transmitted during the GI. In an implementation, the CP of an OFDM symbol is a prefix of the OFDM symbol (the CP precedes the OFDM symbol) that repeats an end portion of the OFDM symbol in the time domain. In an example, the GI duration equals to the duration of the CP which is a fraction of a discrete Fourier transform (DFT) period of the OFDM symbol.

The EHT PHY provides support for 0.8 μs, 1.6 μs, and 3.2 μs guard interval (GI) durations.

The EHT PHY provides support for 3.2 μs (1×), 6.4 μs (2×), and 12.8 μs (4×) EHT-long training field (LTF) symbol durations, excluding the GI duration.

The EHT PHY supports a symbol duration, excluding GI, of 3.2 μs for the pre-EHT modulated fields and 12.8 μs for the Data field in an EHT PPDU.

EHT MU PPDU with a 2×EHT-LTF and 0.8 μs GI duration on the EHT-LTF and Data field OFDM symbols.

An EHT STA shall support the following features:
EHT MU PPDU with a 2×EHT-LTF and 1.6 μs GI duration on the EHT-LTF and Data field OFDM symbols.
EHT MU PPDU with a 4×EHT-LTF and 3.2 μs GI duration on the EHT-LTF and Data field OFDM symbols.
EHT TB PPDU with a 1×EHT-LTF and 1.6 μs GI duration on the EHT-LTF and Data field OFDM symbols.
EHT TB PPDU with a 2×EHT-LTF and 1.6 μs GI duration on the EHT-LTF and Data field OFDM symbols.
EHT TB PPDU with a 4×EHT-LTF and 3.2 μs GI duration on the EHT-LTF and Data field OFDM symbols.

An EHT STA may support the following features:
EHT MU PPDU with a 4×EHT-LTF and 0.8 μs GI duration on the EHT-LTF and Data field OFDM symbols.

The structure of the PPDU transmitted by an EHT STA is determined by the TXVECTOR parameters.

The FORMAT parameter determines the overall structure of the PPDU and can take on one of the following values: Non-HT format (NON_HT), HT-mixed format (HT_MF), HT-greenfield format (HT_GF), VHT format (VHT), HE SU PPDU format (HE_SU), HE ER SU format (HE_ER_SU), HE MU PPDU format (HE_MU), HE TB PPDU (HE_TB), EHT MU PPDU format (EHT_MU), EHT TB PPDU format (EHT_TB).

The EHT PHY provides an interface to the EHT MAC through an extension of the generic PHY service interface. The interface includes TXVECTOR, RXVECTOR, PHYCONFIG_VECTOR, and TRIG_VECTOR.

The EHT MAC uses the TXVECTOR to supply the EHT PHY with per-PPDU transmit parameters. The EHT PHY uses the RXVECTOR to inform the EHT MAC of the received PPDU parameters. The EHT MAC uses the PHYCONFIG_VECTOR to configure the EHT PHY for operation that is independent of frame transmission or reception. The EHT MAC uses the TRIG_VECTOR to configure the EHT PHY to receive EHT TB PPDUs over each assigned RU or MRU.

An EHT STA may receive a PPDU that contains the L-STF, L-LTF, L-SIG, RL-SIG, and U-SIG fields, but has a PHY Version Identifier field in the U-SIG field other than 0. In such cases, for forward compatibility, it shall still report the information from the version independent fields in the U-SIG field within the RXVECTOR. A value of PHY_VER_UNKNOWN is defined in the RXVECTOR parameter FORMAT to indicate such a PPDU format. When the RXVECTOR parameter FORMAT is PHY_VER_UNKNOWN, the RXVECTOR contains only six parameters: FORMAT, RSSI_LEGACY, CH_BANDWIDTH, TXOP_DURATION, BSS_COLOR, and UPLINK_FLAG.

If the condition FORMAT is EHT_MU or EHT_TB, the parameter GI_TYPE indicates the length of the GI for the EHT-LTF and Data fields in both TXVECTOR and RXVECTOR. Enumerated type: 0u8s_GI indicates 0.8 μs, 1u6s_GI indicates 1.6 μs, and 3u2s_GI indicates 3.2 μs. The length of GI for pre-EHT modulated field is 0.8 μs.

If the condition FORMAT is PHY_VER_UNKNOWN, the parameter GI_TYPE is not present.

During transmission, a PSDU (in the SU case) or one or more PSDUs (in the MU case) are processed (i.e., scrambled and coded) and appended to the PHY preamble to create the PPDU. At the receiver, the PHY preamble is processed to aid in the detection, demodulation, and delivery of the PSDU.

Two EHT PPDU formats are defined: EHT MU PPDU and EHT TB PPDU.

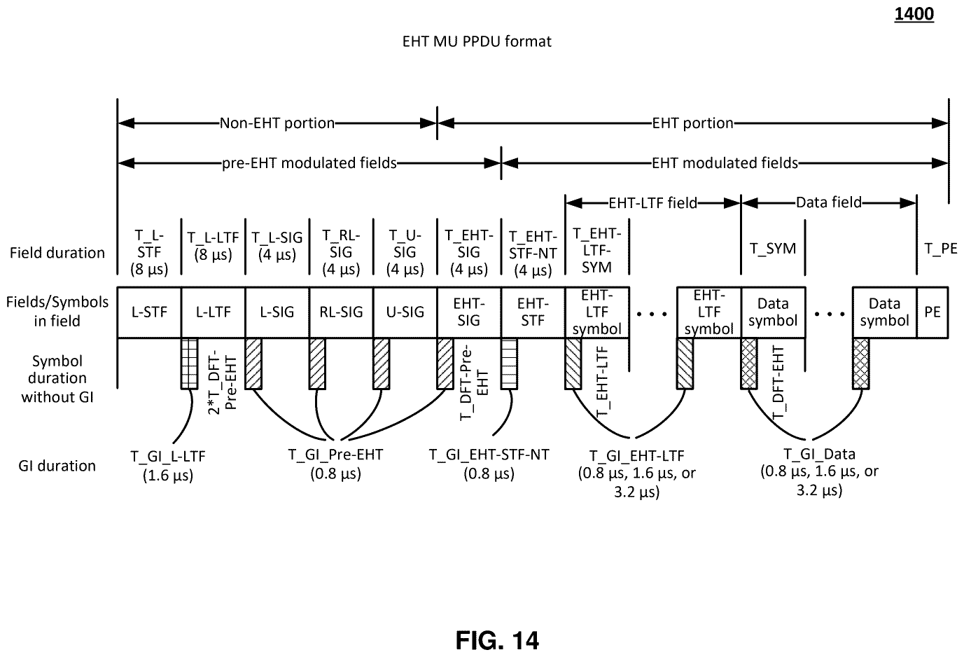

FIG. 14 illustrates another example format of a PPDU. The PPDU may be an example of an EHT MU PPDU which may be used for transmission to one or more users.

As shown in FIG. 14, the EHT MU PPDU comprises a non-HT short training field (L-STF), a non-HT long training field (L-LTF), a non-HT signal field (L-SIG), a repeated Non-HT signal field (RL-SIG), an universal signal field (U-SIG), an EHT signal field (EHT-SIG), an EHT short training field (EHT-STF), an EHT long training field (EHT-LTF), a data field carrying the PSDU(s), and a packet extension (PE) field.

The L-STF, L-LTF, L-SIG, RL-SIG, U-SIG, and EHT-SIG fields are referred to as pre-EHT modulated fields, while the EHT-STF, EHT-LTF, Data, and PE fields are referred to as the EHT modulated fields.

The generation of each field in an EHT PPDU uses many of the following blocks: a) Pre-forward error correction (FEC) PHY padding, b) Scrambler, c) FEC (binary convolutional code (BCC) or low density parity check (LDPC)) encoders, d) Post-FEC PHY padding, e) Stream parser, f) Segment parser (for RU or MRU size larger than 996 tones), g) BCC interleaver, h) Constellation mapper, i) dual-carrier modulation (DCM) tone mapper, j) Pilot insertion, k) Replication over multiple 20 MHz (for bandwidth greater than 20 MHz), l) LDPC tone mapper, m) Segment deparser, n) Frequency domain duplication if EHT-MCS equals 14, o) cyclic shift diversity (CSD) per spatial stream insertion, p) Spatial mapper, q) Frequency mapping, r) Inverse discrete Fourier transform (IDFT), s) CSD per chain insertion, t) GI insertion, and u) Windowing.

The GI insertion for each field of the EHT PPDU encoding process is described as follows.
a) To construct the L-STF field, insert a GI (T_GI_Pre-EHT) for L-STF field.
b) To construct the L-LTF field, insert a GI (T_GI_L-LTF) for L-LTF field.
c) To construct the L-SIG and RL-SIG fields, insert a GI (T_GI_Pre-EHT).
d) To construct the U-SIG field, insert a GI (T_GI_Pre-EHT).
e) For an EHT MU PPDU, to construct the EHT-SIG field, insert a GI (T_GI_Pre-EHT).
f) To construct the EHT-STF field, insert a GI (T_GI_EHT-STF-NT for EHT MU PPDU, or T_GI_EHT-STF-T for EHT TB PPDU, respectively).
g) To construct the EHT-LTF field, insert a GI (T_GI_EHT) indicated by the TXVECTOR parameter GI_TYPE.
h) To construct the Data field, insert a GI (T_GI_Data) determined by the TXVECTOR parameter GI_TYPE.

The timing-related constants are described as follows.

T_DFT_Pre-EHT is an IDFT/DFT period of 3.2 μs for the pre-EHT modulated fields.

T_DFT_EHT is an IDFT/DFT period of 12.8 μs for the EHT data field.

T_GI_Pre-EHT is a GI duration of 0.8 μs for the pre-EHT modulated fields excluding the L-LTF field.

T_GI_L-LTF is a GI duration of 1.6 μs for the L-LTF field.

T_GI_Data is the GI duration for the data field. The value of T_GI_Data is one out of T_GI1_Data, T_GI2_Data, or T_GI4_Data, depending on the GI used for the data field.

T_GI1_Data is a base GI duration of 0.8 μs for the data field.

T_GI2_Data is a double GI duration of 1.6 μs for the data field.

T_GI4_Data is a quadruple GI duration of 3.2 μs for the data field.

T_GI_EHT is the GI duration for the EHT-LTF field, same as T_GI_Data.

T_GI_EHT-STF-NT is a GI duration of 0.8 μs for EHT MU PPDU.

T_GI_EHT-STF-T is a GI duration of 1.6 μs for EHT TB PPDU.

T_SYM indicates an OFDM symbol interval for EHT data field. The value of T_SYM is one out of T_SYM1, T_SYM2, or T_SYM4 depending on the GI used for EHT data field.

T_SYM1 indicates an OFDM symbol duration with base GI, where the value of T_SYM1 is 13.6 μs=T_DFT_EHT+T_GI1_Data=1.0625×T_DFT_EHT.

T_SYM2 indicates an OFDM symbol duration with double GI, where the value of T_SYM2 is 14.4 μs=T_DFT_EHT+T_GI2_Data=1.125×T_DFT_EHT.

T_SYM4 indicates an OFDM symbol duration with quadruple GI, where the value of T_SYM4 is 16 μs=T_DFT_EHT+T_GI4_Data=1.25×T_DFT_EHT.

T_L-STF indicates a non-HT short training field duration. The value of T_L-STF is 8 μs=10×T_DFT_Pre-EHT/4.

T_L-LTF indicates a non-HT long training field duration. The value of T_L-LTF is 8 μs=2×T_DFT_Pre-EHT+T_GI_L-LTF.

T_L-SIG indicates a non-HT signal field duration. The value of T_L-SIG is 4 μs.

T_RL-SIG indicates a repeated non-HT signal field duration. The value of T_RL-SIG is 4 μs.

T_U-SIG indicates an U-SIG field duration in an EHT PPDU. The value of T_U-SIG is 8 μs=2×4 μs.

T_U-SIG-R indicates an U-SIG field duration in an EHT ER preamble. The value of T_U-SIG is 16 μs=4×4 μs.

T_EHT-SIG indicates an duration of each OFDM symbol in EHT-SIG field. The value of T_EHT-SIG is 4 μs=T_DFT_Pre-EHT+T_GI_Pre-EHT.

T_EHT-STF-T indicates an EHT-STF field duration for an EHT TB PPDU. The value of T_EHT-STF-T is 8 μs=5×1.6 μs.

T_EHT-STF-NT indicates an EHT-STF field duration for an EHT MU PPDU. The value of T_EHT-STF-NT is 4 μs=5×0.8 μs.

T_EHT-LTF indicates a duration of each OFDM symbol without GI in EHT-LTF field. The value of T_EHT-LTF is one out of T_ EHT-LTF-1X, T_ EHT-LTF-2X, or T_ EHT-LTF-4X, depending upon the EHT-LTF duration used.

T_EHT-LTF-1X indicates a duration of each 1×EHT-LTF OFDM symbol without GI. The value of T_EHT-LTF-1X is 3.2 μs.

T_EHT-LTF-2X indicates a duration of each 2×EHT-LTF OFDM symbol without GI. The value of T_EHT-LTF-2X is 6.4 μs.

T_EHT-LTF-4X indicates a duration of each 4×EHT-LTF OFDM symbol without GI. The value of T_EHT-LTF-4X is 12.8 μs.

T_EHT-LTF-SYM indicates a duration of each OFDM symbol including GI in the EHT-LTF field.

T_SYML indicates an OFDM symbol duration including GI in the pre-EHT modulation fields.

T_PE indicates a duration of the PE field. The value of T_PE is one out of 0, 4 μs, 8 μs. 12 μs, 16 μs, or 20 μs, depending on the actual packet extension duration used.

It is anticipated that future IEEE 802.11 standards provide various mechanisms to support the quality of service (QoS) requirements of low-latency and high-throughput of AP and STAs.

Inter-symbol interference (ISI) between OFDM symbols that are adjacent in time degrades the orthogonality between the subcarriers and impairs performance. ISI may be caused by delay spread in the channel and filtering. To minimize the impact of ISI, a guard interval (GI) is added between adjacent OFDM symbols.

Determining the GI duration required for a transmission may be based on various factors. For example, the factors may comprise a discrete Fourier transform (DFT) size being used in fields of a PPDU, delay spread of channel state information, and the modulation and coding scheme (MCS) order. In an example, the GI duration to be used for the transmission may comprise a base GI duration of 0.8 μs, a double GI duration of 1.6 μs, or a quadruple GI duration of 3.2 μs.

For example, in a single-AP transmission, a first STA receiving a first PPDU from an AP may experience a different delay spread compared to a second STA receiving the first PPDU from the AP. In another example, the AP transmitting a second PPDU to the first STA may use a different MCS order compared to transmitting the second PPDU to the second STA. As such, the AP may determine to use a GI with a different duration to receive from or transmit to the first STA and the second STA. For example, the AP may choose the GI with double GI duration to meet the requirements of transmission to both STAs.

Similarly, in a multi-AP transmission comprising transmission by at least two APs, each AP may require a different GI for its transmission.

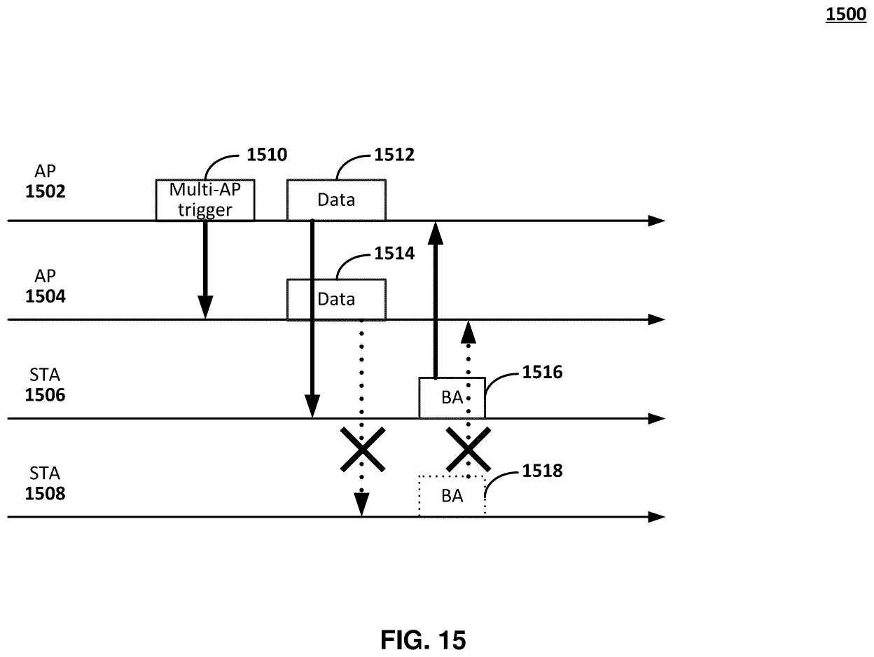

FIG. 15 is an example 1500 that illustrates an existing multi-AP transmission procedure. Example 1500 may be an example of multi-AP data transmission phase 1016. As shown in FIG. 15, example 1500 includes an AP 1502, an AP 1504, a STA 1506, and a STA 1508. In an example, AP 1502 may be a master AP, and AP 1504 may be a slave AP. In an example, STA 1506 may be associated with AP 1502, and STA 1508 may be associated with AP 1504.

In an example, APs 1502 and 1504 may belong to the same ESS as described above in FIG. 1. In such a case, APs 1502 and 1504 may be connected by a DS to support ESS features. In an example, APs 1502 and 1504 belong to different BSSs.

In an example, APs 1502 and 1504 may form a multi-AP group. In an example, APs 1502 and 1504 may complete a multi-AP setup procedure prior to the beginning of example 1500. In addition, as part of a multi-AP group, APs 1502 and 1504 may be connected by a backhaul. In an example, the backhaul may be a wireless backhaul.

Before example 1500 begins, AP 1502 and AP 1504 may complete a multi-AP selection phase 1010, an optional multi-AP data sharing phase 1012, and an optional multi-AP sounding phase 1014, as described in FIG. 10.

As shown in FIG. 15, example 1500 may include frame exchanges to enable AP 1502 to coordinate with AP 1504 to perform a multi-AP transmission using specific multi-AP transmission schemes with their associated STAs 1506 and 1508, respectively. The multi-AP transmission schemes may include COFDMA, CTDMA, CSR, CBF, JT/JR, or a combination of two or more of the aforementioned schemes.

As shown in FIG. 15, example 1500 may begin with AP 1502 transmitting a frame 1510 to AP 1504. Frame 1510 may include information related to AP 1504 (e.g., an identifier of AP 1504), synchronization information, information related to a specific multi-AP transmission scheme to be used, and/or information related to a resource unit (RU) for use by AP 1504 to acknowledge frame 1510. Frame 1510 may comprise a control frame. For example, frame 1510 may comprise a multi-AP trigger frame.

Frame 1510 may also include information related to a guard interval (GI) to be used by APs 1502 and 1504 for downlink transmission to STAs 1506 and 1508, respectively. In an example, the information related to the GI may comprise an indication of a GI duration (such as 0.8 μs, 1.6 μs, or 3.2 μs) , or an indication of a GI type (such as a “base GI duration”, a “double GI duration”, or a “quadruple GI duration”).

In an example, AP 1502 may determine the GI duration or the GI type based on local information of AP 1502. For example, the local information of AP 1502 may comprise the GI to be used for a downlink transmission from AP 1502 to its associated STA 1506.

AP 1504 may receive frame 1510 and may use the synchronization information to synchronize with AP 1502.

Subsequently, APs 1502 and 1504 may perform downlink transmissions to their associated STAs 1506 and 1508, respectively. Specifically, AP 1502 may transmit a frame 1512 using the GI indicated in frame 1510 to STA 1506. Concurrently, AP 1504 may transmit a frame 1514 using the GI indicated in frame 1510 to STA 1508.

AP 1502 may determine the GI indicated in frame 1510 based on a GI duration required for transmitting frame 1512 to STA 1506. The GI duration required for transmitting frame 1512 is based on a DFT size being used for fields of the PPDU carrying frame 1512.

In an example, GI durations required for transmission of frames 1512 and 1514 may be different. In an example, a channel from AP 1504 to STA 1508 may exhibit a longer delay spread than a channel from AP 1502 to STA 1506. As such, the GI duration required for transmitting frame 1514 from AP 1504 may thus be longer than the GI duration required for transmission frame 1512 from AP 1502. For example, AP 1502 transmitting frame 1512 may require a GI duration that is equal to the “double GI duration” of 1.6 μs. For example, AP 1504 transmitting frame 1514 may require a GI duration that is longer than the “double GI duration” of 1.6 μs.

In an example, AP 1502 may select the GI indicated in frame 1510 as a “double GI duration” of 1.6 μs based on the requirement to transmit/receive frame 1512. As such, STA 1506 may receive frame 1512 from AP 1502 without experiencing inter-symbol interference (ISI) between adjacent OFDM symbols of the PPDU carrying frame 1512. STA 1506 may acknowledge frame 1512 by transmitting a BlockAck (BA) frame 1516 to AP 1502. However, as the selected GI indicated in frame 1510 is shorter than required to transmit/receive frame 1514, STA 1508 may experience inter-symbol interference between adjacent OFDM symbols while receiving the PPDU carrying frame 1514. In an example, STA 1508 may fail to decode frame 1514 correctly and may not acknowledge frame 1514.

As shown in example 1500, the improper selection of a GI duration for the multi-AP transmission by AP 1502 may cause a failure of the transmission from AP 1504 to STA 1508. This may reduce reliability, increase retransmissions, and introduce significant latency and overhead in the multi-AP network.

Embodiments of the present disclosure, as further described below, address the above-described problems of existing multi-AP procedures. In a first aspect, a first AP may receive from a second AP a first frame indicating a first guard interval (GI). The first GI may be for a transmission from the second AP to a STA, or vice versa. The first AP may transmit to the second AP a second frame indicating a second GI. The second GI may be for the transmission from the second AP to the STA, or vice versa. In an embodiment, the second GI may be based on the first GI. In an embodiment, the transmission from the second AP to the STA, or vice versa, may be part of a multi-AP transmission comprising the first AP and the second AP. The first AP may select the second GI to accommodate (e.g., reduce or eliminate ISI for) all transmissions of the multi-AP transmission. Reliability of the multi-AP transmission can thus be improved and the latency caused by unsuccessful transmissions may be reduced.

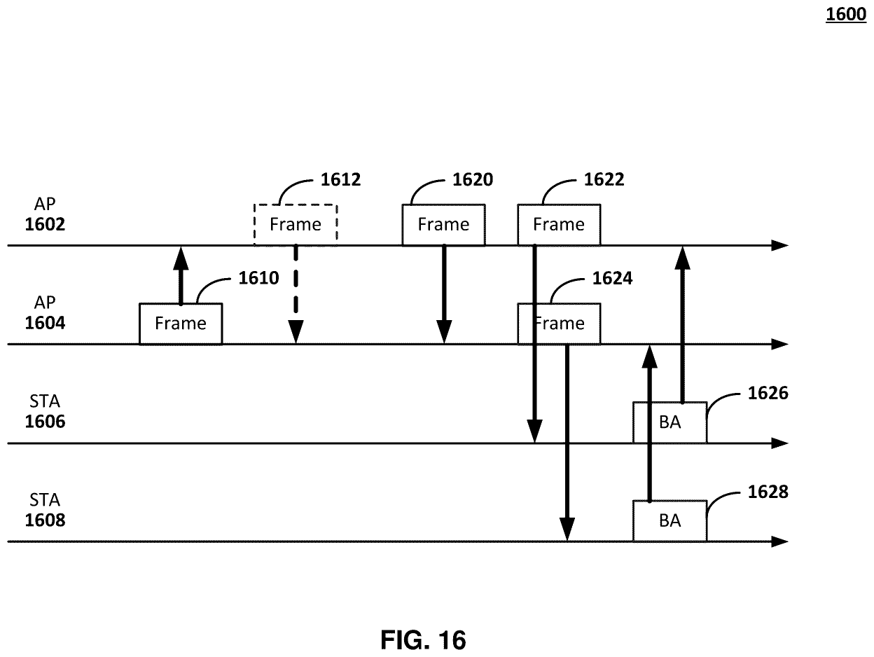

FIG. 16 is an example 1600 that illustrates a guard interval (GI) coordination procedure for multi-AP communication according to an embodiment. Example 1600 is provided for the purpose of illustration only and is not limiting. As shown in FIG. 16, example 1600 includes an AP 1602, an AP 1604, a STA 1606, and a STA 1608. In an example, STA 1606 may be associated with AP 1602. In an example, STA 1608 may be associated with AP 1604. AP 1602, AP 1604, STA 1606, and/or STA 1608 may each comprise a multi-link device (MLD).

In an example, APs 1602 and 1604 may belong to the same ESS as described above in FIG. 1. In such a case, APs 1602 and 1604 may be connected by a DS to support ESS features. In an example, APs 1602 and 1604 belong to different BSSs. In an embodiment, AP 1602 may belong to a first BSS and AP 1604 may belong to a second BSS. In an embodiment, the second BSS may comprise an overlapping basic service set (OBSS) relative to the first BSS.

In an embodiment, AP 1602 and 1604 may form a multi-AP group. It is assumed in example 1600, APs 1602 and 1604 may complete a multi-AP setup procedure prior to the beginning of example 1600. In addition, as part of a multi-AP group, APs 1602 and 1604 may be connected by a backhaul. In an example, the backhaul may be a wireless backhaul.

Before example 1600 begins, AP 1602 and AP 1604 may complete a multi-AP selection phase 1010, an optional multi-AP data sharing phase 1012, and an optional multi-AP sounding phase 1014, as described in FIG. 10.

As shown in FIG. 16, example 1600 may include frame exchanges to enable AP 1602 to coordinate with AP 1604 to perform a multi-AP transmission using specific multi-AP transmission schemes with their associated STAs 1606 and 1608, respectively. The multi-AP transmission schemes may include COFDMA, CTDMA, CSR, CBF, JT/JR, or a combination of two or more of the aforementioned schemes.

It is assumed in example 1600 that both AP 1602 and AP 1604 support a GI coordination capability. In an example, support of the GI coordination capability allows AP 1604 to transmit frames (such as frame 1610 described below) to share information related to a first GI with AP 1602. In an example, support of the GI coordination capability allows AP 1602 to receive and process frames (such as frame 1610) and transmit frames (such as frame 1620 described below) to determine a second GI for the multi-AP transmission based on the first GI. In another example, support of the GI coordination capability allows AP 1602 and AP 1604 to transmit frames respectively (such as frames 1622 and 1624 described below), using the second GI, to STAs 1606 and 1608, respectively.

In an embodiment, prior to the beginning of example 1600 (not shown in FIG. 16), APs 1602 and 1604 may exchange a first frame and a second frame to exchange capability information. In an embodiment, the first frame may comprise the capability information of AP 1602, including a first indication of support by AP 1602 of the GI coordination capability. In an embodiment, the second frame may comprise the capability information of AP 1604, including a second indication of support by AP 1604 of the GI coordination capability. In an embodiment, the first frame and the second frame may be exchanged during a multi-AP setup procedure or a multi-AP selection phase. In an embodiment, the first frame and the second frame may comprise a management frame.

As shown in FIG. 16, example 1600 may begin with AP 1604 transmitting to AP 1602 a frame 1610 indicating a first GI. In an embodiment, the first GI may be for a first transmission from AP 1604 to STA 1608. In an embodiment, frame 1610 may comprise a request to AP 1602 for AP 1604 to use the first GI for the first transmission.

In an embodiment, frame 1610 may comprise a management frame or a data frame.

In an embodiment, AP 1604 may determine the first GI from a set of GIs. For example, the first GI may comprise a duration chosen from a base GI duration of 0.8 μs, a double GI duration of 1.6 μs, or a quadruple GI duration of 3.2 μs. In an example, AP 1604 may select the first GI based on a delay spread of a channel from AP 1604 to STA 1608 over which the first transmission is to be transmitted. In an example, AP 1604 may determine that the first transmission requires a GI duration longer than the “double GI duration”. For example, AP 1604 may determine that the first transmission must use a GI duration equal to at least the “quadruple GI duration” of 3.2 μs to avoid ISI at STA 1608.

In an embodiment, the first transmission may comprise transmission of a PPDU. The PPDU may comprise a frame 1624. The first GI may be for a data field of the PPDU. That is, the first GI may be used in OFDM symbols of the data field of the PPDU. In an embodiment, the first transmission may be scheduled during a transmission opportunity (TXOP) owned/obtained by AP 1602. In an embodiment, the first transmission may be a part of a multi-AP transmission initiated by AP 1602 and comprising AP 1604.

As shown in FIG. 16, AP 1602 may transmit to AP 1604 a frame 1612 to acknowledge the reception of frame 1610. In an example, frame 1612 may comprise an acknowledgment frame. For example, frame 1612 may comprise a BlockAck (BA) frame. In an embodiment, frame 1612 may comprise a response to frame 1610.

In an embodiment, AP 1602 may transmit to AP 1604 a frame 1620 indicating a second GI. For example, the second GI may comprise a duration chosen from a base GI duration of 0.8 μs, a double GI duration of 1.6 μs, or a quadruple GI duration of 3.2 μs.

In an embodiment, the second GI may be for the first transmission from AP 1604 to STA 1608 and for a second transmission from AP 1602 to STA 1606. The second transmission may comprise a frame 1622.

In an example, GI durations required for the first transmission from AP 1604 to STA 1608 and the second transmission from AP 1602 to STA 1606 may be different. In an example, a channel from AP 1604 to STA 1608 may exhibit a longer delay spread than a channel from AP 1602 to STA 1606. As such, the GI duration required for the first transmission may be longer than the GI duration required for the second transmission. For example, the second transmission may require a GI duration that is equal to the “double GI duration” of 1.6 μs. As such, the first transmission may require a GI duration that is longer than the “double GI duration” of 1.6 μs.

In an embodiment, AP 1602 may determine the second GI based on the first GI. For example, the second GI may be at least equal to the first GI. In an embodiment, AP 1602 may select the second GI such that it satisfies the GI duration required for the first transmission as well as the GI duration required for the second transmission. In an embodiment, the first transmission may use the second GI. In an embodiment, the second transmission may also use the second GI. As such, STAs 1608 and 1606 may receive the first transmission and the second transmission, respectively, without experiencing ISI.

In an embodiment, the second transmission may comprise a second PPDU. The second PPDU may comprise frame 1622. The second GI may be for a data field of the second PPDU. That is, the second GI may be used in OFDM symbols of the data field of the second PPDU. In an embodiment, the second transmission may be scheduled during the TXOP owned/obtained by AP 1602. In an embodiment, the second transmission may be a part of a multi-AP transmission initiated by AP 1602 and comprising AP 1604.

In an embodiment, frame 1620 may initiate the multi-AP transmission. In an example, the multi-AP transmission may comprise the first transmission and the second transmission. In an embodiment, AP 1602 may transmit frame 1620 triggering AP 1604 for the multi-AP transmission.

In an embodiment, frame 1620 may allow synchronization of the first transmission of frame 1624 and the second transmission of frame 1622.

In an embodiment, frame 1620 may comprise a trigger frame. In an example, frame 1620 may comprise a multi-AP trigger frame.

As shown in FIG. 16, STA 1606 may transmit a frame 1626 to acknowledge the reception of frame 1622. In an embodiment, STA 1608 may transmit a frame 1628 to acknowledge the reception of frame 1628. In an example, frames 1626 and 1628 may comprise a BA frame.

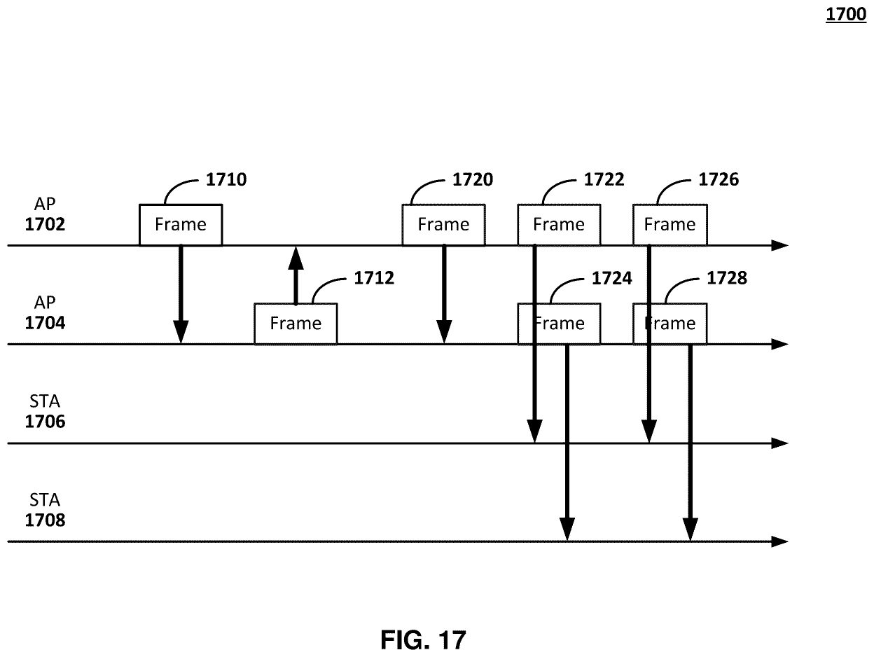

FIG. 17 is an example 1700 that illustrates another guard interval (GI) coordination procedure for multi-AP communication according to an embodiment. Example 1700 is provided for the purpose of illustration only and is not limiting. As shown in FIG. 17, example 1700 includes an AP 1702, an AP 1704, a STA 1706, and a STA 1708. In an example, STA 1706 may be associated with AP 1702. In an example, STA 1708 may be associated with AP 1704. AP 1702, AP 1704, STA 1706, and/or STA 1708 may comprise a multi-link device (MLD).

In an example, APs 1702 and 1704 may belong to the same ESS as described above in FIG. 1. In such a case, APs 1702 and 1704 may be connected by a DS to support ESS features. In an example, APs 1702 and 1704 belong to different BSSs. In an embodiment, AP 1702 may belong to a first BSS and AP 1704 may belong to a second BSS. In an embodiment, the second BSS may comprise an overlapping basic service set (OBSS) relative to the first BSS.

In an embodiment, AP 1702 and 1704 may form a multi-AP group. It is assumed in example 1700, APs 1702 and 1704 may complete a multi-AP setup procedure prior to the beginning of example 1700. In addition, as part of a multi-AP group, APs 1702 and 1704 may be connected by a backhaul. In an example, the backhaul may be a wireless backhaul.

Before example 1700 begins, AP 1702 and AP 1704 may complete a multi-AP selection phase 1010, an optional multi-AP data sharing phase 1012, as described in FIG. 10.

As shown in FIG. 17, example 1700 may include frame exchanges to enable AP 1702 to coordinate with AP 1704 to perform channel sounding for multi-AP transmission with their associated STAs 1706 and 1708, respectively.

It is assumed in example 1700 that both AP 1702 and AP 1704 support a GI coordination capability. In an example, support of the GI coordination capability allows AP 1702 to transmit frames (such as frame 1710 described below) to request for a first GI from AP 1704. In an example, support of the GI coordination capability allows AP 1704 to receive and process frames (such as frame 1710) and transmit frames (such as frame 1712 described below) to share information related to the first GI with AP 1702. In an example, support of the GI coordination capability allows AP 1702 to receive and process frames (such as frame 1712), and transmit frames (such as frame 1720 described below) to determine a second GI for the sounding phase for multi-AP transmission based on the first GI. In another example, support of the GI coordination capability allows AP 1702 and AP 1704 to transmit frames respectively (such as frame 1722 and 1724 described below), using the second GI, to STAs 1706 and 1708, respectively.

In an embodiment, prior to the beginning of example 1700 (not shown in FIG. 17), APs 1702 and 1704 may exchange a first frame and a second frame to exchange capability information. In an embodiment, the first frame may comprise the capability information of AP 1702, including a first indication of support by AP 1702 of the GI coordination capability. In an embodiment, the second frame may comprise the capability information of AP 1704, including a second indication of support by AP 1704 of the GI coordination capability. In an embodiment, the first frame and the second frame may be exchanged during a multi-AP setup procedure or a multi-AP selection phase. In an embodiment, the first frame and the second frame may comprise a management frame.

As shown in FIG. 17, example 1700 may begin with AP 1702 transmitting to AP 1704 a frame 1710 requesting a first GI. In an embodiment, frame 1710 may solicit feedback from AP 1704. In an embodiment, the first GI may be for a first transmission from AP 1704 to STA 1708. In an embodiment, the first GI may be for AP 1704 to use the first GI for the first transmission.

In an embodiment, frame 1710 may comprise a management frame comprising an action frame. In an embodiment, frame 1710 may comprise a control frame comprising a trigger frame.

In an embodiment, AP 1704 may transmit a frame 1712 in response to frame 1710. In an embodiment, frame 1712 may comprise the feedback solicited by frame 1710. In an embodiment, frame 1712 may indicate the first GI as requested in frame 1710.

In an embodiment, frame 1712 may comprise a management frame comprising an action frame. In an embodiment, frame 1712 may comprise a data frame comprising a QoS null frame.

In an embodiment, AP 1704 may determine the first GI from a set of GIs. For example, the first GI may comprise a duration chosen from a base GI duration of 0.8 μs, a double GI duration of 1.6 μs, or a quadruple GI duration of 3.2 μs. In an example, AP 1704 may select the first GI based on a delay spread of a channel from AP 1704 to STA 1708 over which the first transmission is to be transmitted. In an example, AP 1704 may determine that the first transmission requires a GI duration longer than the “double GI duration.” For example, AP 1704 may determine that the first transmission must use a GI duration equal to at least the “quadruple GI duration” of 3.2 μs to avoid ISI at STA 1708.

In an embodiment, the first transmission may comprise transmission of a PPDU. The PPDU may comprise a frame 1724 and/or a frame 1728. The first GI may be for a training field of the PPDU. That is, the first GI may be used in OFDM symbols of the training field of the PPDU. In an embodiment, the training field may comprise a short training field or a long training field. In an example, frame 1724 may comprise a null data packet announcement (NDPA) frame. In an example, frame 1728 may comprise a null data packet (NDP) frame. In an embodiment, the first transmission may be scheduled during a TXOP owned/obtained by AP 1702. In an embodiment, the first transmission may be a part of a sounding phase for the multi-AP transmission initiated by the AP 1702 and comprising AP 1704.

In an embodiment, AP 1702 may transmit to AP 1704 a frame 1720 indicating a second GI. For example, the second GI may comprise a duration chosen from a base GI duration of 0.8 μs, a double GI duration of 1.6 μs, or a quadruple GI duration of 3.2 μs.

In an embodiment, the second GI may be for the first transmission from AP 1704 to STA 1708 and for a second transmission from AP 1702 to STA 1706. The second transmission may comprise a frame 1722 and/or a frame 1726. The first transmission and the second transmission may form a multi-AP transmission. The multi-AP transmission may be a coordinated multi-AP transmission.

In an example, GI durations required for the first transmission from AP 1704 to STA 1708 and for the second transmission from AP 1702 to STA 1706 may be different. In an example, a channel from AP 1704 to STA 1708 may exhibit a longer delay spread than a channel from AP 1702 to STA 1706. In an example, the GI duration required for the first transmission may be longer than the GI duration required for the second transmission. For example, the second transmission may require a GI duration that is equal to the “double GI duration” of 1.6 μs. As such, the first transmission may require a GI duration that is longer than the “double GI duration” of 1.6 μs.

In an embodiment, AP 1702 may determine the second GI based on the first GI. For example, the second GI may be at least equal to the first GI. In an embodiment, AP 1702 may select the second GI such that it satisfies the GI duration required for the first transmission as well as the GI duration required for the second transmission. In an embodiment, the first transmission may use the second GI. In an embodiment, the second transmission may also use the second GI. As such, STAs 1708 and 1706 may receive the first transmission and the second transmission, respectively, without experiencing ISI.

In an embodiment, the second transmission may comprise transmission of a second PPDU. The second PPDU may comprise frame 1722 or frame 1726. The second GI may be for a training field of the second PPDU. That is, the second GI may be used in OFDM symbols of the training field of the second PPDU. In an embodiment, the training field of the second PPDU may comprise a short training field or a long training field. In an example, frame 1722 may comprise an NDPA frame. In an example, frame 1726 may comprise an NDP frame. In an embodiment, the second transmission may be scheduled during the TXOP owned/obtained by AP 1702. In an embodiment, the second transmission may be a part of a sounding phase for the multi-AP transmission initiated by AP 1702 and comprising AP 1704.

In an embodiment, frame 1720 may initiate the sounding phase for the multi-AP transmission. In an embodiment, AP 1702 may transmit frame 1720 triggering AP 1704 for the sounding phase for the multi-AP transmission.

In an embodiment, frame 1720 may allow synchronization of the transmission of frame 1724 and frame 1722. In an embodiment, frame 1720 may further allow synchronization of the transmission of frame 1726 and frame 1728.

In an embodiment, frame 1720 may comprise a trigger frame. In an example, frame 1720 may comprise a multi-AP trigger frame.

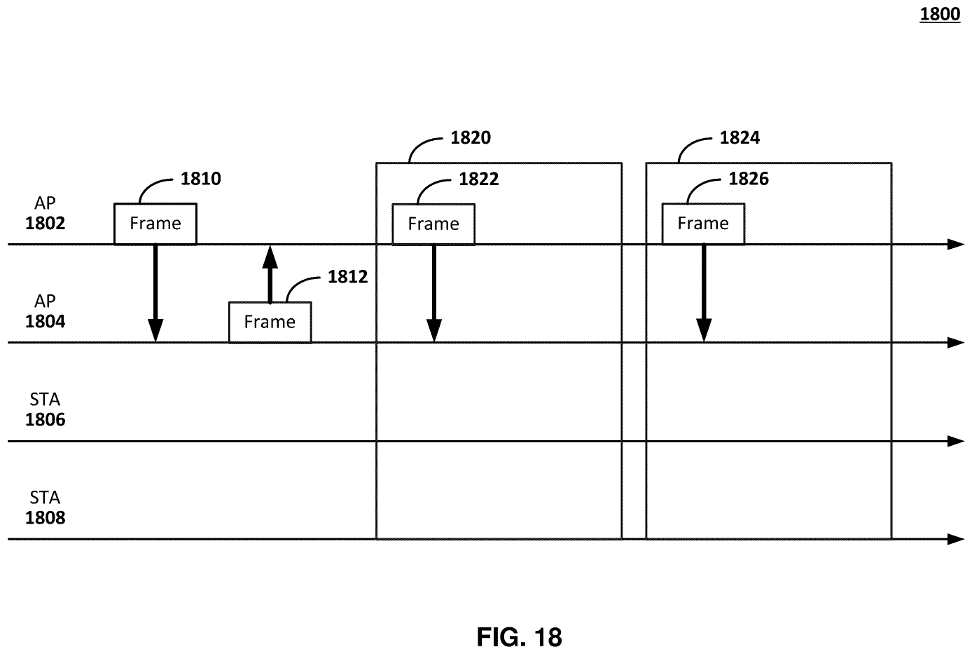

FIG. 18 is an example 1800 that illustrates another guard interval (GI) coordination procedure for multi-AP communication according to an embodiment. Example 1800 is provided for the purpose of illustration only and is not limiting. As shown in FIG. 18, example 1800 includes an AP 1802, an AP 1804, a STA 1806, and a STA 1808. In an example, STA 1806 may be associated with AP 1802. In an example, STA 1808 may be associated with AP 1804. AP 1802, AP 1804, STA 1806, and/or STA 1808 may comprise a multi-link device (MLD).

In an example, APs 1802 and 1804 may belong to the same ESS as described above in FIG. 1. In such a case, APs 1802 and 1804 may be connected by a DS to support ESS features. In an example, APs 1802 and 1804 belong to different BSSs. In an embodiment, AP 1802 may belong to a first BSS and AP 1804 may belong to a second BSS. In an embodiment, the second BSS may comprise an overlapping basic service set (OBSS) relative to the first BSS.

In an embodiment, AP 1802 and 1804 may form a multi-AP group. It is assumed in example 1800, APs 1802 and 1804 may complete a multi-AP setup procedure prior to the beginning of example 1800. In addition, as part of a multi-AP group, APs 1802 and 1804 may be connected by a backhaul. In an example, the backhaul may be a wireless backhaul.

Before example 1800 begins, AP 1802 and AP 1804 may complete a multi-AP selection phase 1010, an optional multi-AP data sharing phase 1012, as described in FIG. 10.

As shown in FIG. 18, example 1800 may include frame exchanges to enable AP 1802 to coordinate with AP 1804 to perform channel sounding and a multi-AP transmission with their associated STAs 1806 and 1808, respectively.

It is assumed in example 1800 that both AP 1802 and AP 1804 support a GI coordination capability. In an example, support of the GI coordination capability allows AP 1802 to transmit frames (such as frame 1810 described below) to request a first GI and a second GI from AP 1804. In an example, support of the GI coordination capability allows AP 1804 to receive and process frames (such as frame 1810) and transmit frames (such as frame 1812 described below) to share information related to the first GI and the second GI with AP 1802. In an example, support of the GI coordination capability allows AP 1802 to receive and process frames (such as frame 1812) and transmit frames (such as frame 1822 described below) to determine a third GI for a sounding phase of the multi-AP transmission based on the first GI. In an example, support of the GI coordination capability allows AP 1802 to receive and process frames (such as frame 1812) and transmit frames (such as frame 1826 described below) to determine a fourth GI for the multi-AP transmission based on the second GI. In another example, support of the GI coordination capability allows AP 1802 and AP 1804 to transmit frames (such as frames 1722, 1724, 1726, 1728 described in FIG. 17 in a phase 1820) using the third GI, and to transmit frames (such as frames 1622 and 1624 described in FIG. 16 in a phase 1824), using the fourth GI, to STAs 1806 and 1808.

In an embodiment, prior to the beginning of example 1800 (not shown in FIG. 18), APs 1802 and 1804 may exchange a first frame and a second frame to exchange capability information. In an embodiment, the first frame may comprise the capability information of AP 1802, including a first indication of support by AP 1802 of the GI coordination capability. In an embodiment, the second frame may comprise the capability information of AP 1804, including a second indication of support by AP 1804 of the GI coordination capability. In an embodiment, the first frame and the second frame may be exchanged during a multi-AP setup procedure or a multi-AP selection phase. In an embodiment, the first frame and the second frame may comprise a management frame.

As shown in FIG. 18, example 1800 may begin with AP 1802 transmitting to AP 1804 a frame 1810 requesting a first GI and a second GI. In an embodiment, frame 1810 may solicit feedback from AP 1804. In an embodiment, the first GI may be for a first transmission from AP 1804 to STA 1808 in phase 1820. In an embodiment, the second GI may be for a second transmission from AP 1804 to STA 1808 in phase 1824.

In an embodiment, frame 1810 may comprise a management frame comprising an action frame. In an embodiment, frame 1810 may comprise a control frame comprising a trigger frame.

In an embodiment, the first GI and the second GI may be requested by AP 1802 by transmitting separate frames, similar to frame 1810, to AP 1804.

In an embodiment, AP 1804 may transmit a frame 1812 in response to frame 1810. In an embodiment, frame 1812 may comprise feedback solicited by frame 1810. In an embodiment, frame 1812 may indicate the first GI and the second GI as requested in frame 1810.

In an embodiment, the first GI and the second GI may be indicated in separate frames, similar to frame 1812, in response to separate frames, similar to frame 1810, from AP 1802.

In an embodiment, frame 1812 may comprise a management frame comprising an action frame. In an embodiment, frame 1812 may comprise a data frame comprising a QoS null frame.

In an embodiment, AP 1804 may determine the first GI and the second GI from a set of GIs. For example, the first GI and/or the second GI may comprise a duration chosen from a base GI duration of 0.8 μs, a double GI duration of 1.6 μs, or a quadruple GI duration of 3.2 μs. In an example, AP 1804 may select the first GI based on a delay spread of a channel from AP 1804 to STA 1808 over which the first transmission is to be transmitted in phase 1820. In an example, AP 1802 may select the second GI based on a delay spread of the channel from AP 1804 to STA 1808 over which the second transmission is to be transmitted in phase 1824. In an example, the first GI and the second GI may be based on a type of information carried by the first transmission (e.g., training fields) and the second transmission (e.g., data field), respectively.

In an embodiment, the first transmission in phase 1820 may comprise a first PPDU. The first PPDU may comprise a frame (such as frame 1724 or a frame 1728 described in FIG. 17). The first GI may be for a training field of the first PPDU. In an embodiment, the training field may comprise a short training field or a long training field. In an example, the first PPDU may comprise a NDPA frame and/or a NDP frame. In an embodiment, the first transmission may be scheduled during a first TXOP owned/obtained by AP 1802. In an embodiment, the first transmission may be a part of a sounding phase for the multi-AP transmission initiated by AP 1802 and comprising AP 1804.

In an embodiment, the second transmission in phase 1824 may comprise a second PPDU. The second PPDU may comprise a frame (such as frame 1624 described in FIG. 16). The second GI may be for a data field of the second PPDU. In an embodiment, the second transmission may be scheduled during a second TXOP owned/obtained by AP 1802. In an example, the second TXOP may be the same as the first TXOP. In another example, the second TXOP may be different from the first TXOP. In an embodiment, the second transmission may be a part of a multi-AP transmission initiated by AP 1802 and comprising AP 1804.

In an example, AP 1804 may select the first GI and the second GI to be the same. For example, AP 1804 may determine that both the first transmission and the second transmission require a GI duration longer than the “double GI duration.” For example, AP 1804 may determine the first GI and the second GI must use the “quadruple GI duration” of 3.2 μs to avoid ISI at STA 1808.

In another example, AP 1804 may select the first GI and the second GI to be different. In an example, AP 1804 may determine that a field of the first PPDU of the first transmission requires a GI duration longer than a required GI duration for a field of the second PPDU of the second transmission. For example, AP 1804 may determine the first GI as the “base GI duration” of 3.2 μs and the second GI as the “quadruple GI duration” of 1.6 μs, to avoid ISI at STA 1808.

In an embodiment, AP 1802 may transmit to AP 1804 a frame 1822 indicating a third GI. For example, the third GI may comprise a duration chosen from a base GI duration of 0.8 μs, a double GI duration of 1.6 μs, or a quadruple GI duration of 3.2 μs.

In an embodiment, the third GI may be for the first transmission from AP 1804 to STA 1808 in phase 1820 and/or for a third transmission from AP 1802 to STA 1806 in phase 1820. In an example, the third transmission may comprise a frame (such as frame 1722 or frame 1726 described in FIG. 17).

In an example, GI durations required for the first transmission from AP 1804 to STA 1808 and for the third transmission from AP 1802 to STA 1806 may be different in phase 1820. In an example, in phase 1820 the GI duration required for the first transmission from AP 1804 transmitting a frame (such as frame 1724 or 1728 described in FIG. 17) may be longer than the GI duration required for the third transmission from AP 1802 transmitting a frame (such as frame 1722 or 1726 described in FIG. 17). For example, the first transmission in phase 1820 may require a GI duration that is equal to the “base GI duration” of 0.8 μs. For example, the second transmission in phase 1820 may require for a GI duration that is longer than the “double GI duration” of 1.6 μs.

In an embodiment, AP 1802 may determine the third GI based on the first GI. For example, the third GI may be at least equal to the first GI. In an embodiment, AP 1802 may select the third GI such that it satisfies the GI duration required for the first transmission as well as the GI duration required for the third transmission.

In an embodiment, the first transmission in phase 1820 may use the third GI. In an embodiment, the third transmission in phase 1820 may also use the third GI. As such, STAs 1808 and 1806 may receive the first transmission and the third transmission, respectively, without experiencing ISI.

In an embodiment, the third transmission may comprise a third PPDU. The third PPDU may comprise a frame (such as frame 1722 or a frame 1726 described in FIG. 17). The third GI may be for a training field of the third PPDU. That is, the third GI may be used in OFDM symbols of the training field of the third PPDU. In an embodiment, the training field may comprise a short training field or a long training field. In an embodiment, the third transmission may be scheduled during the first TXOP owned/obtained by AP 1802. In an embodiment, the third transmission may be a part of a sounding phase for the multi-AP transmission initiated by the AP 1802 and comprising AP 1804.

In an embodiment, frame 1822 may initiate the sounding phase for the multi-AP transmission. In an embodiment, AP 1802 may transmit frame 1822 triggering AP 1804 for the sounding phase for the multi-AP transmission.

In an embodiment, frame 1822 may allow synchronization of the first transmission of from AP 1804 and the third transmission from AP 1802 in phase 1820.

In an embodiment, frame 1822 may comprise a trigger frame. In an example, frame 1822 may comprise a multi-AP trigger frame.

In an embodiment, AP 1802 may transmit to AP 1804 a frame 1826 indicating a fourth GI. For example, the fourth GI may comprise a duration chosen from a base GI duration of 0.8 μs, a double GI duration of 1.6 μs, or a quadruple GI duration of 3.2 μs.

In an embodiment, the fourth GI may be for the second transmission from AP 1804 to STA 1808 in phase 1824 and for a fourth transmission from AP 1802 to STA 1806 in phase 1824. In an example, the fourth transmission may comprise a frame (such as frame 1622 described in FIG. 16).

In an example, GI durations required for the second transmission from AP 1804 and for the fourth transmissions from AP 1802 may be different in phase 1824. In an example, in phase 1824 the GI duration required for the second transmission from AP 1804 transmitting a frame (such as frame 1624 described in FIG. 16) may be longer than the GI duration required for the fourth transmission from AP 1802 transmitting a frame (such as frame 1622 described in FIG. 16). For example, the second transmission in phase 1824 may require a GI duration that is equal to the “double GI duration” of 0.8 μs. For example, the fourth transmission in phase 1824 may require for a GI duration that is longer than the “double GI duration” of 1.6 μs.

In an embodiment, AP 1802 may determine the fourth GI based on the second GI. For example, the fourth GI may be at least equal to the second GI. In an embodiment, AP 1802 may select the fourth GI such that it satisfies the GI duration required for the second transmission as well as the GI duration required for the fourth transmission.

In an embodiment, a duration of the fourth GI may be the same as a duration of the third GI. In an embodiment, a duration of the fourth GI may be different from a duration of the third GI.

In an embodiment, the second transmission in phase 1824 may use the fourth GI. In an embodiment, the fourth transmission in phase 1824 may also use the fourth GI. As such, STAs 1808 and 1806 may receive the second transmission and the fourth transmission, respectively, without experiencing ISI.

In an embodiment, the fourth transmission may comprise a fourth PPDU. The fourth PPDU may comprise a frame (such as frame 1622 described in FIG. 16). The fourth GI may be for a data field of the fourth PPDU. That is, the fourth GI may be used in OFDM symbols of the data field of the fourth PPDU. In an embodiment, the fourth transmission may be scheduled during the second TXOP owned/obtained by AP 1802. In an embodiment, the fourth transmission may be a part of a sounding phase for the multi-AP transmission initiated by the AP 1802 and comprising AP 1804.

In an embodiment, frame 1826 may initiate the multi-AP transmission. In an embodiment, AP 1802 may transmit frame 1826 triggering AP 1804 for the multi-AP transmission.

In an embodiment, frame 1826 may allow synchronization of the second transmission from AP 1804 and the fourth transmission from AP 1802 in phase 1824.

In an embodiment, frame 1826 may comprise a trigger frame. In an example, frame 1820 may comprise a multi-AP trigger frame.

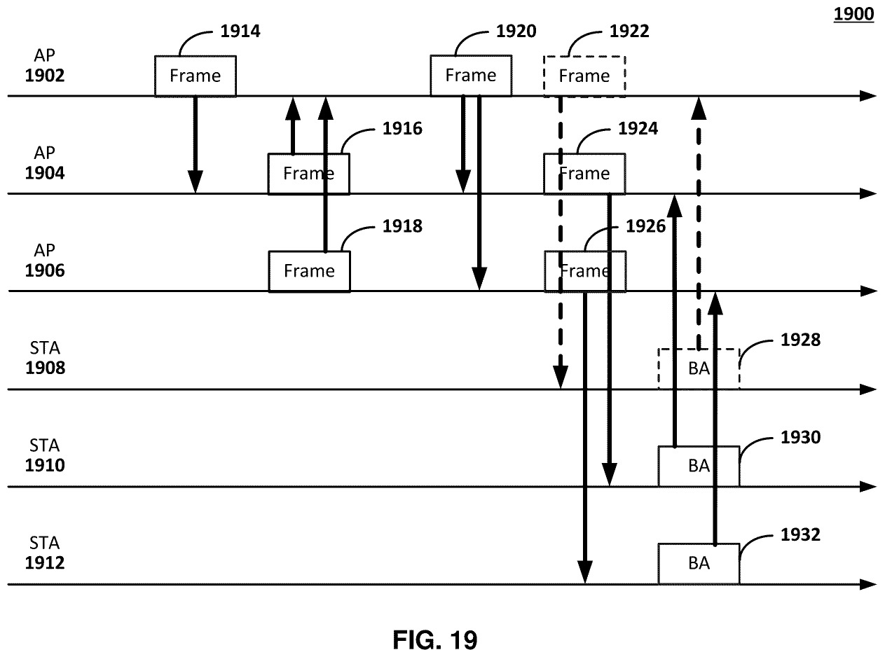

FIG. 19 is an example 1900 that illustrates another guard interval (GI) coordination procedure for multi-AP communication according to an embodiment. Example 1900 is provided for the purpose of illustration only and is not limiting. As shown in FIG. 19, example 1900 includes an AP 1902, an AP 1904, an AP 1906, a STA 1908, a STA 1910, and a STA 1912. In an example, STA 1908 may be associated with AP 1902. In an example, STA 1910 may be associated with AP 1904. In an example, STA 1912 may be associated with AP 1906. AP 1902, AP 1904, AP 1906, STA 1908, STA 1910, and/or STA 1912 may comprise a multi-link device (MLD).

In an example, APs 1902, 1904, and 1906 may belong to the same ESS as described above in FIG. 1. In such a case, APs 1902, 1904, and 1906 may be connected by a DS to support ESS features. In an example, APs 1902, 1904, and 1906 belong to different BSSs. In an embodiment, AP 1902 may belong to a first BSS, AP 1904 may belong to a second BSS, and AP 1906 may belong to a third BSS. In an embodiment, the second BSS and the third BSS may comprise an overlapping basic service set (OBSS) relative to the first BSS.

In an embodiment, AP 1902, 1904, and 1906 may form a multi-AP group. It is assumed in example 1900, APs 1902, 1904, and 1906 may complete a multi-AP setup procedure prior to the beginning of example 1900. In addition, as part of a multi-AP group, APs 1902, 1904, and 1906 may be connected by a backhaul. In an example, the backhaul may be a wireless backhaul.

Before example 1900 begins, AP 1902, AP 1904, and AP 1906 may complete a multi-AP selection phase 1010, an optional multi-AP data sharing phase 1012, as described in FIG. 10.

As shown in FIG. 19, example 1900 may include frame exchanges to enable AP 1902 to coordinate with AP 1904 and AP 1906 to perform a multi-AP transmission using specific multi-AP transmission schemes with their associated STAs 1908, 1910, and 1912, respectively.

It is assumed in example 1900 that both AP 1902, AP 1904, and AP 1906 support a GI coordination capability. In an example, support of the GI coordination capability allows AP 1902 to transmit frames (such as frame 1914 described below) to request a first GI and a second GI from AP 1704. In an example, support of the GI coordination capability allows AP 1904 and AP 1906 to receive and process frames (such as frame 1914) and transmit frames (such as frames 1916 and 1918 described below) to share information related to the first GI and the second GI with AP 1902, respectively. In an example, support of the GI coordination capability allows AP 1902 to receive and process frames (such as frames 1916 and 1918) and transmit frames (such as frame 1920 described below) to determine a third GI for the multi-AP transmission based on the first GI and the second GI. In another example, support of the GI coordination capability allows AP 1902, AP 1904, and AP 1906 to transmit frames (such as frames 1922, 1924, 1926, 1928, 1930, and 1932, described in FIG. 19) using the third GI.

In an embodiment, prior to the beginning of example 1900 (not shown in FIG. 19), APs 1902, 1904, and 1906 may exchange a first frame, a second frame, and a third frame to exchange capability information. In an embodiment, the first frame may comprise the capability information of AP 1902, including a first indication of support by AP 1902 of the GI coordination capability. In an embodiment, the second frame may comprise the capability information of AP 1904, including a second indication of support by AP 1904 of the GI coordination capability. In an embodiment, the third frame may comprise the capability information of AP 1906, including a third indication of support by AP 1906 of the GI coordination capability. In an embodiment, the first frame, the second, and the third frame may be exchanged in a multi-AP setup procedure or in a multi-AP selection phase. In an embodiment, the first frame, the second frame, and the third frame may comprise a management frame.

As shown in FIG. 19, example 1900 may begin with AP 1902 transmitting to AP 1904 and AP 1906 a frame 1914 requesting a first GI and a second GI from APs 1904 and 1906, respectively. In an embodiment, frame 1914 may solicit feedback from AP 1904 and AP 1906. In an embodiment, the first GI may be for a first transmission from AP 1904 to STA 1910. In an embodiment, the second GI may be for a second transmission from AP 1906 to STA 1912.

In an embodiment, frame 1914 may comprise a management frame comprising an action frame. In an embodiment, frame 1914 may comprise a control frame comprising a trigger frame.

In an embodiment, the first GI and the second GI may be requested by AP 1902 by transmitting separate frames, similar to frame 1914, to APs 1904 and AP 1906.

In an embodiment, AP 1904 may transmit a frame 1916 in response to frame 1914. In an embodiment, frame 1916 may comprise feedback solicited by frame 1914. In an embodiment, frame 1916 may indicate the first GI as requested in frame 1914.

In an embodiment, frame 1916 may comprise a management frame comprising an action frame. In an embodiment, frame 1916 may comprise a data frame comprising a QoS null frame.

In an embodiment, AP 1904 may determine the first GI from a set of GIs. For example, the first GI may comprise a duration chosen from a base GI duration of 0.8 μs, a double GI duration of 1.6 μs, or a quadruple GI duration of 3.2 μs. In an example, AP 1906 may select the first GI based on a delay spread of a channel from AP 1904 to STA 1910 over which the first transmission is to be transmitted. In an example, AP 1904 may determine that the first transmission requires a GI duration longer than the “double GI duration.” For example, AP 1904 may determine that the first transmission must use a GI duration equal to at least the “quadruple GI duration” of 3.2 μs to avoid ISI at STA 1910.

In an embodiment, the first transmission may comprise a first PPDU. The first PPDU may comprise a frame 1924. The first GI may be for a data field of the first PPDU. In an embodiment, the first transmission may be scheduled during a TXOP owned/obtained by AP 1902. In an embodiment, the first transmission may be a part of a multi-AP transmission initiated by AP 1902 and comprising AP 1904 and AP 1906.

In an embodiment, AP 1906 may transmit a frame 1918 in response to frame 1914. In an embodiment, frame 1918 may comprise feedback solicited by frame 1914. In an embodiment, frame 1918 may indicate the second GI as requested in frame 1914.

In an embodiment, frame 1918 may comprise a management frame comprising an action frame. In an embodiment, frame 1918 may comprise a data frame comprising a QoS null frame.

In an embodiment, AP 1906 may determine the second GI from a set of GIs. For example, the second GI may comprise a duration chosen from a base GI duration of 0.8 μs, a double GI duration of 1.6 μs, or a quadruple GI duration of 3.2 μs. In an example, AP 1906 may select the second GI based on a delay spread of a channel from AP 1906 to STA 1912 over which the second transmission is to be transmitted. In an example, AP 1906 may determine that the second transmission requires a GI duration at least equal to the “base GI duration.” For example, AP 1906 may determine that the second GI must use a GI duration equal to at least the “base GI duration” of 0.8 μs.

In an embodiment, the second transmission may comprise a second PPDU. The second PPDU may comprise a frame 1926. The second GI may be for a data field of the second PPDU. In an embodiment, the second transmission may be scheduled during the TXOP owned/obtained by AP 1902. In an embodiment, the second transmission may be a part of the multi-AP transmission initiated by AP 1902 and comprising AP 1904 and AP 1906.

In an embodiment, AP 1902 may transmit to AP 1904 and AP 1906 a frame 1920 indicating a third GI. For example, the third GI may comprise a duration chosen from a base GI duration of 0.8 μs, a double GI duration of 1.6 μs, or a quadruple GI duration of 3.2 μs.

In an embodiment, the third GI may be for the first transmission from AP 1904 to STA 1910, the second transmission from AP 1906 to STA 1912, and an optional third transmission from AP 1902 to STA 1908. The third transmission may comprise an optional frame 1922.

In an example, GI durations required for the first transmission from AP 1904 to STA 1910, the second transmission from AP 1906 to STA 1912, and the optional third transmissions from AP 1902 to STA 1908 may be different. In an example, a channel from AP 1904 to STA 1910 may exhibit a longer delay spread than a channel from AP 1906 to STA 1912 and/or a channel from AP 1902 to STA 1908. As such, the GI duration required for the first transmission may be longer than the GI duration required for the second transmission and/or the third transmission. For example, the second transmission may require a GI duration that is equal to the “base GI duration” of 0.8 μs. As such, the first transmission may require for a GI duration that is longer than the “double GI duration” of 1.6 μs.

In an embodiment, AP 1902 may determine the third GI based on the first GI and the second GI. For example, the third GI may be at least equal to the first GI or the second GI, whichever is longer. In an embodiment, AP 1902 may select the third GI such that it satisfies the GI duration required for the first transmission, the GI duration required for the second transmission, as well as the GI duration required for the third transmission. In an embodiment, the first transmission may use the third GI. In an embodiment, the second transmission may also use the third GI. In an embodiment, the third transmission may also use the third GI. As such, STAs 1910, 1912 and 1908 may receive the first transmission, the second transmission, and the third transmission, respectively, without experiencing ISI.

In an embodiment, the optional third transmission may comprise an optional third PPDU. The third PPDU may comprise frame 1922. The third GI may be for a data field of the third PPDU. In an embodiment, the third transmission may be scheduled during the TXOP owned/obtained by AP 1902. In an embodiment, the third transmission may be a part of the multi-AP transmission initiated by AP 1902 and comprising AP 1904 and AP 1906.

In an embodiment, frame 1920 may initiate the multi-AP transmission. In an embodiment, AP 1902 may transmit frame 1920 triggering AP 1904 and AP 1906 for the multi-AP transmission.

In an embodiment, frame 1920 allow synchronization of the first transmission from AP 1904, the second transmission from AP 1906, and the optional third transmission from AP 1902.

In an embodiment, frame 1920 may comprise a trigger frame. In an example, frame 1920 may comprise a multi-AP trigger frame.

As shown in FIG. 19, STA 1908 may transmit an optional frame 1928 to acknowledge the reception of optional frame 1922. In an embodiment, STA 1910 may transmit a frame 1930 to acknowledge the reception of frame 1924. In an embodiment, STA 1912 may transmit a frame 1932 to acknowledge the reception of frame 1926. In an example, frames 1928, 1930, and 1932 may comprise a BA frame.

In an embodiment, frame 1610 described in FIG. 16, frame 1712 described in FIG. 17, frame 1812 described in FIG. 18, and/or frames 1916 and 1918 described in FIG. 19 may be management frames, such as action frames.

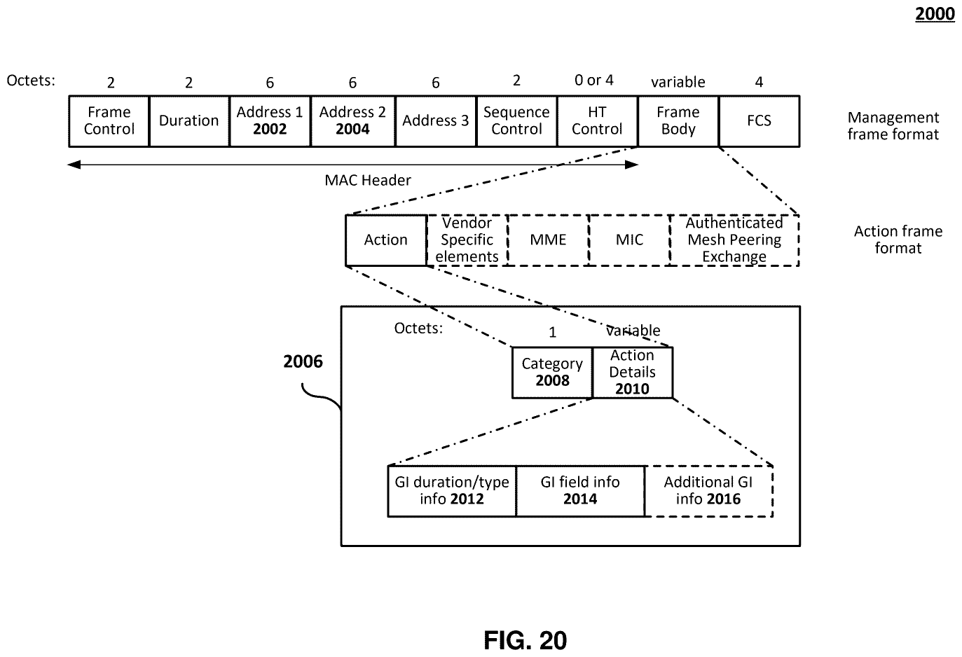

FIG. 20 illustrates an example action frame 2000 which may be used according to embodiments. For example, action frame 2000 may be an embodiment of frame 1610, 1712, 1812, 1916, or 1918. In an example, action frame 2000 may comprise a public action frame.

In an embodiment, action frame 2000 may include information supporting GI coordination. In an embodiment, information supporting GI coordination may comprise an indication of a GI duration or an indication of a GI type. In an embodiment, information supporting GI coordination may comprise an indication of a PPDU field in which the GI is used. The PPDU may be a UHR PPDU.

In an example, action frame 2000 may be transmitted by a first AP to a second AP. For example, the first AP may be an embodiment of AP 1604 described in FIG. 16, AP 1704 described in FIG. 17, AP 1804 described in FIG. 18, or APs 1904 and 1906 described in FIG. 19. The second AP may be an embodiment of AP 1602 described in FIG. 16, AP 1702 described in FIG. 17, AP 1802 described in FIG. 18, or AP 1902 described in FIG. 19.

In an embodiment, action frame 2000 may indicate a GI for a transmission from the first AP to a STA. For example, the STA may be an embodiment of STA 1608 described in FIG. 16. In an example, action frame 2000 may comprise a GI coordination notification frame. The GI coordination notification frame may be an unsolicited frame, such as frame 1610, that indicates a GI for the transmission.

In an embodiment, action frame 2000 may include a request to the second AP for the first AP to use the GI for a transmission from the first AP to a STA. For example, the STA may be an embodiment of STA 1608 described in FIG. 16. In an example, action frame 2000 may comprise a GI coordination request frame. The GI coordination request frame may be an unsolicited frame, such as frame 1610, that requests a GI for the transmission.

In an embodiment, action frame 2000 may include a response to the second AP in response to a request from the second AP for the first AP to use a GI for a transmission from the first AP to a STA. For example, the STA may be an embodiment of STA 1708 described in FIG. 17 or STA 1808 described in FIG. 18. In an example, action frame 2000 may comprise a GI coordination response frame. The GI coordination response frame may be a solicited frame, such as frame 1712 or 1812, that responds to a request frame that requests the use of a GI by the first AP.

As shown in FIG. 20, action frame 2000 may include a frame control field, a duration field, one or more address fields, a sequence control field, an HT control field, a frame body, and an FCS field.

In an example, an address 1 field 2002 may indicate a receiver address (RA) of action frame 2000. The RA may comprise the address of the second AP. In an example, an address 2 field 2004 may indicate a transmitter address (TA). The TA may comprise the address of the first AP.

As shown in FIG. 20, the frame body of action frame 2000 may include an action field 2006. In an embodiment, action field 2006 may comprise information supporting GI coordination. In an embodiment, the information supporting GI coordination may indicate a GI for the transmission from the first AP to the STA. In an embodiment, action field 2006 may indicate a request to the second AP for the first AP to use the GI for the transmission from the first AP to the STA. In an embodiment, action field 2006 may indicate a response to a request from the second AP for the first AP to use the GI for the transmission from the first AP to the STA. In an embodiment, action field 2006 may be a GI coordination action field.

In an embodiment, action field 2006 may include a category subfield 2008 that indicates that action frame 2000 is for GI coordination.

In an embodiment, action field 2006 may include an action details field 2010.

In an embodiment, action details field 2010 may include a GI duration/type information subfield 2012, a GI field information subfield 2014, and an optional additional GI information subfield 2016.

In an embodiment, GI duration/type information subfield 2012 may comprise an indication of a GI duration or a GI type. For example, the GI duration or GI type may comprise a base GI duration of 0.8 μs, a double GI duration of 1.6 μs, or a quadruple GI duration of 3.2 μs.

In an embodiment, GI field information subfield 2014 may comprise an indication of a field of the PPDU carrying the transmission from the first AP to the STA, where the GI indicated in GI duration/type information subfield 2012 is used for the indicated field of the PPDU. In an example, the field may comprise a short training field (STF), a long training field (LTF), or a data field. The PPDU may be a UHR PPDU.

In an embodiment, additional GI information subfield 2016 may be present when action frame 2000 is used for indicating more than one GI for an additional transmission from the first AP. For example, additional GI information subfield 2016 may be present when action frame 2000 is used as an embodiment of frame 1812 described in FIG. 18. In an embodiment, additional GI information subfield 2016 may comprise subfields for a second GI, where the subfields may be similar to GI duration/type information subfield 2012 and GI field information subfield 2014.

In an embodiment, frame 1610 described in FIG. 16, frames 1712 described in FIG. 17, frame 1812 described in FIG. 18, and frames 1916, 1918 described in FIG. 19, may be data frames, such as QoS null frames.

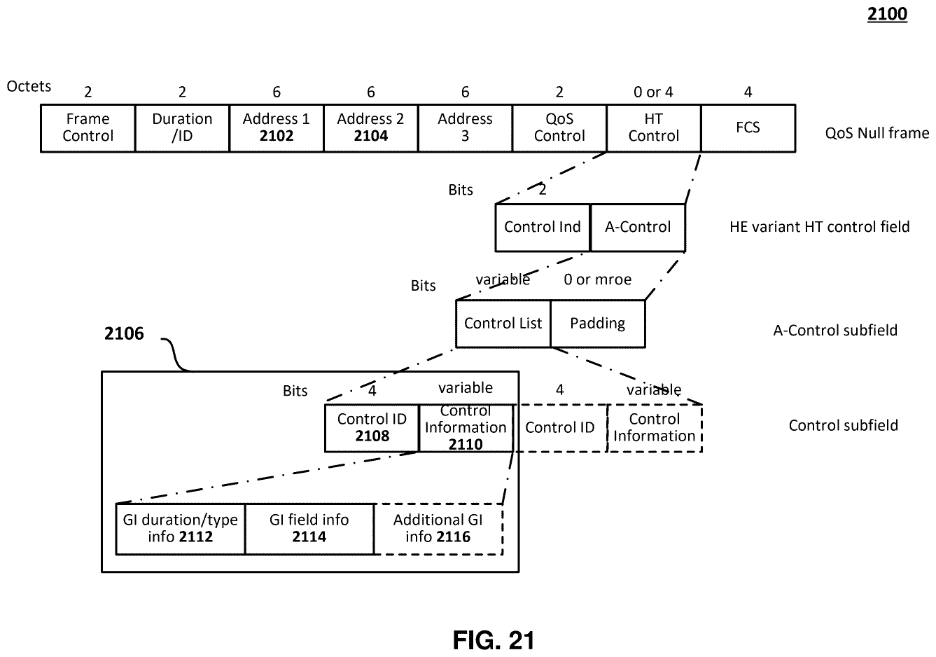

FIG. 21 illustrates an example QoS null frame 2100 which may be used according to embodiments. For example, QoS null frame 2100 may be an embodiment of frame 1610 described in FIG. 16, frames 1712 described in FIG. 17, frame 1812 described in FIG. 18, and frames 1916 and 1918 described in FIG. 19.

In an embodiment, QoS null frame 2100 may include information supporting GI coordination. In an embodiment, information supporting GI coordination may comprise an indication of a GI duration or an indication of a GI type. In an embodiment, information supporting GI coordination may comprise an indication of a PPDU field in which the GI is used. The PPDU may be a UHR PPDU.

In an example, QoS null frame 2100 may be transmitted by a first AP to a second AP. For example, the first AP may be an embodiment of AP 1604 described in FIG. 16, AP 1704 described in FIG. 17, AP 1804 described in FIG. 18, or APs 1904 and 1906 described in FIG. 19. The second AP may be an embodiment of AP 1602 described in FIG. 16, AP 1702 described in FIG. 17, AP 1802 described in FIG. 18, or AP 1902 described in FIG. 19.

In an embodiment, QoS frame 2100 may indicate a GI for a transmission from the first AP to a STA. For example, the STA may be an embodiment of STA 1608 described in FIG. 16. In an example, QoS null frame 2100 may comprise a GI coordination notification frame. The GI coordination notification frame may be an unsolicited frame, such as frame 1610, that indicates a GI for the transmission.

In an embodiment, QoS frame 2100 may include feedback to the second AP in response to a solicitation from the second AP for the first AP to use a GI for a transmission from the first AP to a STA. For example, the STA may be an embodiment of STA 1708 described in FIG. 17, STA 1808 described in FIG. 18 or STA 1910 or 1912 described in FIG. 19. In an example, QoS null frame 2100 may comprise a GI coordination feedback frame. The GI coordination response frame may be a solicited frame, such as frame 1712, 1812, 1916, or 1918, that responds to a trigger frame that solicits the use of a GI by the first AP.

As shown in FIG. 21, QoS null frame 2100 may include a frame control field, a duration field, one or more address fields, a QoS control field, an HT control field, and an FCS field.

In an example, an address 1 field 2102 may comprise a receiver address (RA) of QoS null frame 2100. The RA may comprise the address of the current AP. In an example, an address 2 field 2104 may indicate a transmitter address (TA). The TA may comprise the address of the first AP.

As illustrated by FIG. 21, QoS null frame 2100 may include an HT control field. In an example, HT control field may include an A-Control subfield. The A-Control subfield may include a control list subfield including one or more control subfields. In an embodiment, a control subfield 2106 of the control list subfield may include information supporting GI coordination. In an embodiment, the information supporting GI coordination may indicate a GI for the transmission from the first AP to the STA. In an embodiment, control subfield 2106 may indicate feedback to a solicitation from the second AP for the first AP to use the GI for the transmission from the first AP to the STA. In an embodiment, control subfield 2106 may be a GI coordination control subfield.

In an embodiment, control subfield 2106 may include a control ID subfield 2108 that indicates that QoS null frame 2100 is for GI coordination.

In an embodiment, control subfield 2106 may include a control information subfield 2110 that may include a GI duration/type information subfield 2112, a GI field information subfield 2114, and an optional additional GI information subfield 2116.

In an embodiment, GI duration/type information subfield 2112 may comprise an indication of a GI duration or a GI type. For example, the GI duration or GI type may comprise a base GI duration of 0.8 μs, a double GI duration of 1.6 μs, or a quadruple GI duration of 3.2 μs.

In an embodiment, GI field information subfield 2114 may comprise an indication of a field of the PPDU carrying the transmission from the first AP to the STA, where the GI indicated in GI duration/type information subfield 2112 is used for the indicated field of the PPDU. In an example, the field may comprise a short training field (STF), a long training field (LTF), or a data field. The PPDU may be a UHR PPDU.

In an embodiment, additional GI information subfield 2116 may be present when action frame 2100 is used for indicating more than one GI for an additional transmission from the first AP. For example, additional GI information subfield 2116 may be present when action frame 2100 is used as an embodiment of frame 1812 described in FIG. 18. In an embodiment, additional GI information subfield 2116 may comprise subfields for a second GI, where the subfields may be similar to GI duration/type information subfield 2112 and GI field information subfield 2114.

As would be understood by a person of skill in the art based on the teachings herein, the embodiments as described by the above examples may be readily extended to cases including more than two STAs.

As would be understood by a person of skill in the art based on the teachings herein, the embodiments as described by the above examples may be readily extended to cases including more than two APs.

As would be understood by a person of skill in the art based on the teachings herein, the embodiments as described by the above examples may be readily extended to scenarios in which any of the APs or any of the STAs may comprise an MLD, comprising at least one affiliated AP or affiliated STA.

As would be understood by a person of skill in the art based on the teachings herein, the embodiments as described by the above examples may be readily extended to cases including a transmission from a STA to an AP. The transmission may be a part of a multi-AP uplink transmission.

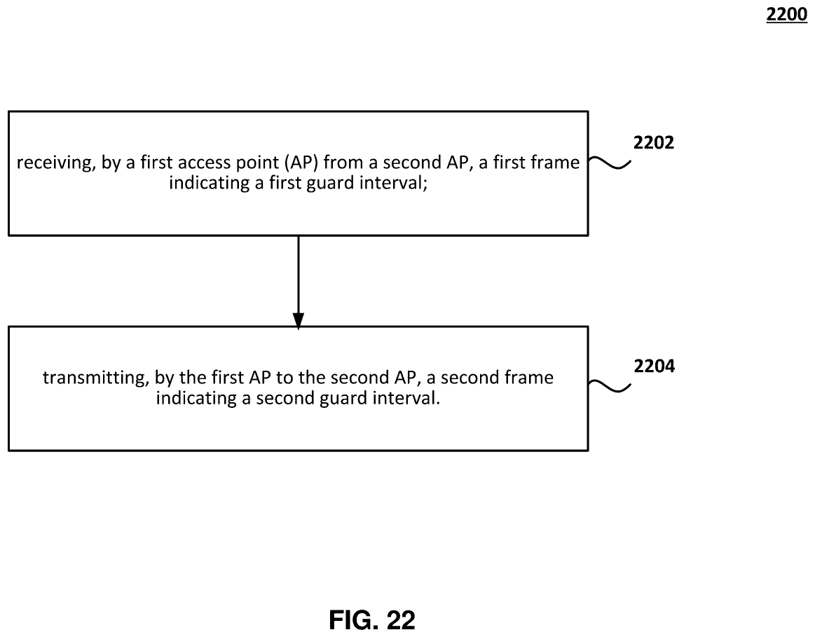

FIG. 22 illustrates an example process 2200 according to an embodiment. Example process 2200 is provided for the purpose of illustration only and is not limiting of embodiments. Process 2200 may be performed by a first AP.

As shown in FIG. 22, process 2200 begins in step 2202, which includes receiving, by a first access point (AP) from a second AP, a first frame indicating a first guard interval (GI).

In step 2204, process 2200 includes transmitting, by the first AP to the second AP, a second frame indicating a second GI.

In an embodiment, the second GI is based on the first GI.

In an embodiment, the first GI or the second GI is for a transmission from the second AP to a station (STA).

In an embodiment, the transmission comprises a physical layer protocol data unit (PPDU), and the first guard interval or the second guard interval is for a data field or a training field of the PPDU.

In an embodiment, the training field comprises a short training field or a long training field.

In an embodiment, the transmission is scheduled during a transmission opportunity (TXOP) of the first AP.

In an embodiment, the transmission uses the second GI.

In an embodiment, the transmission is part of a multi-AP transmission initiated by the first AP and comprising the second AP.

In an embodiment, the transmission is part of a sounding phase for a multi-AP transmission.

In an embodiment, process 2200 may further comprise receiving, by the first AP from the second AP, a third frame indicating a third GI.

In an embodiment, the transmission comprises a PPDU, and the first GI is for a data field of the PPDU and the third GI is for a training field of the PPDU.

In an embodiment, the third frame is the same as the first frame.

In an embodiment, process 2200 may further comprise transmitting, by the first AP to the second AP, a fourth frame requesting the first GI.

In an embodiment, the fourth frame solicits the first frame.

In an embodiment, where the multi-AP transmission further comprises a third AP, process 2200 may further comprise receiving, by the first AP from the third AP, a fifth frame indicating a fourth GI.

In an embodiment, the second GI is based on the first GI and the fourth GI.

In an embodiment, the first frame comprises a management frame.

In an embodiment, the management frame comprises a field or element indicating the first guard interval.

In an embodiment, the first frame comprises a data frame.

In an embodiment, the data frame comprises a field indicating the first GI.

In an embodiment, the second frame comprises a management frame or a control frame.

In an embodiment, process 2200 may further comprise receiving, by the first AP from the second AP, a first indication of support by the second AP of a capability coordinating GI; and transmitting, by the first AP to the second AP, a second indication of support by the first AP of the capability coordinating GI.

In an embodiment, the first AP and the second AP form a multi-AP group.

In an embodiment, the first AP belongs to a basic service set (BSS) and the second AP belongs to a first overlapping basic service set (OBSS) relative to the BSS.

In an embodiment, the first GI or the second GI is for a transmission from a STA to the second AP.

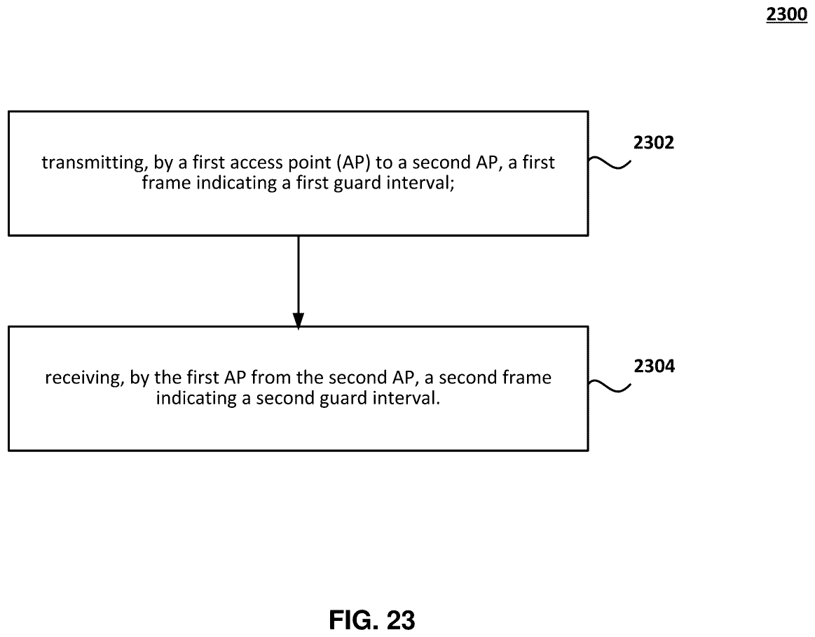

FIG. 23 illustrates an example process 2300 according to an embodiment. Example process 2300 is provided for the purpose of illustration only and is not limiting of embodiments. Process 2300 may be performed by a first AP.

As shown in FIG. 23, process 2300 begins in step 2302, which includes transmitting, by a first access point (AP) to a second AP, a first frame indicating a first guard interval (GI).

In step 2304, process 2300 includes receiving, by the first AP from the second AP, a second frame indicating a second GI.

In an embodiment, the second GI is based on the first GI.

In an embodiment, the first GI or the second GI is for a transmission from the second AP to a station (STA).

In an embodiment, the transmission comprises a physical layer protocol data unit (PPDU), and the first GI or the second GI is for a data field or a training field of the PPDU.

In an embodiment, the training field comprises a short training field or a long training field.

In an embodiment, the transmission is scheduled during a transmission opportunity (TXOP) of the second AP.

In an embodiment, process 2300 may further comprise transmitting, by the first AP to the STA, the PPDU using the second GI.

In an embodiment, the transmission is part of a multi-AP transmission initiated by the second AP and comprising the first AP.

In an embodiment, the transmission is part of a sounding phase for a multi-AP transmission.

In an embodiment, process 2300 may further comprise transmitting, by the first AP to the second AP, a third frame indicating a third GI.

In an embodiment, the transmission comprises a PPDU, and the first guard interval is for a data field of the PPDU and the third guard interval is for a training field of the PPDU.

In an embodiment, the third frame is the same as the first frame.

In an embodiment, process 2300 may further comprise receiving, by the first AP from the second AP, a fourth frame requesting the first GI.

In an embodiment, the fourth frame solicits the first frame.

In an embodiment, the first frame comprises a management frame.

In an embodiment, the management frame comprises a field or element indicating the first GI.

In an embodiment, the first frame comprises a data frame.

In an embodiment, the data frame comprises a field indicating the first GI.

In an embodiment, the second frame comprises a management frame or a control frame.

In an embodiment, process 2300 may further comprise transmitting, by the first AP to the second AP, a first indication of support by the first AP of a capability coordinating GI; and receiving, by the first AP from the second AP, a second indication of support by the second AP of the capability coordinating GI.

In an embodiment, the first AP and the second AP form a multi-AP group.

In an embodiment, the first AP belongs to a basic service set (BSS) and the second AP belongs to a first overlapping basic service set (OBSS) relative to the BSS.

In an embodiment, process 2300 may further comprise receiving, by the first AP from a STA, a fourth frame comprising a third GI for the transmission.

In an embodiment, the first GI is based on the third GI.

In an embodiment, the first GI or the second GI is for a transmission from the STA to the first AP.

In an embodiment, process 2300 may further comprise transmitting, by the first AP to the STA, a third frame comprising the second GI.

In an embodiment, the third frame comprises a trigger frame for the transmission.

In an embodiment, process 2300 may further comprise receiving, by the first AP from a STA, a fourth frame comprising a third GI for the transmission.

In an embodiment, the first GI is based on the third GI.

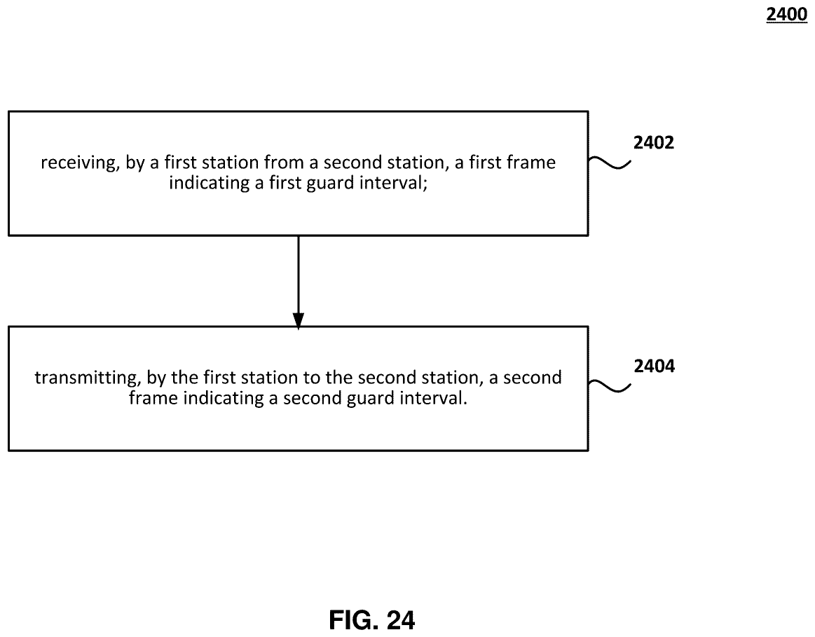

As would be understood by a person of skill in the art based on the teachings herein, embodiments of the present disclosure are not limited to AP-to-AP communication. Instead, embodiments may be extended to AP to non-AP, non-AP to AP, and non-AP to non-AP communication. For illustration, FIG. 24 illustrates an example process 2400 according to an embodiment. Example process 2400 may be performed by a first station, which may comprise an AP STA or a non-AP STA. As shown in FIG. 24, process 2400 includes steps 2402 and 2404.

Step 2402 includes receiving, by the first station from a second station, a first frame indicating a first guard interval. The second station may comprise an AP STA or a non-AP STA. The first guard interval may be for a first transmission from the second station to a third station. The third station may comprise an AP STA or a non-AP STA. In an embodiment, the third station is the same as the first station. The first transmission may be part of a multi-station transmission comprising the first station and the second station.

Step 2404 includes transmitting, by the first station to the second station, a second frame indicating a second guard interval. The second guard interval may be for the first transmission from the second station to the third station. The second station may use the second guard interval for the first transmission from the second station to the third station.

1. A first access point (AP) comprising:
one or more processors; and
memory storing instructions that, when executed by the one or more processors, cause the first AP to:
transmit, to a second AP, a first frame comprising a request to establish a coordinated beamforming (Co-BF) agreement;
receive, from the second AP and in response to the first frame, a second frame indicating that the second AP supports a first guard interval for the Co-BF agreement;
transmit, to the second AP, a third frame indicating the first guard interval for a Co-BF transmission of the Co-BF agreement; and
transmit, to a first STA associated with the first AP and using the first guard interval, a first physical layer protocol data unit (PPDU) for the Co-BF transmission.

2. The first AP of claim 1, wherein the first frame comprises a multi-AP coordination negotiation request frame.

3. The first AP of claim 1, wherein the second frame comprises a multi-AP negotiation response frame.

4. The first AP of claim 1, wherein the Co-BF transmission comprises the transmitting of the first PPDU.

5. The first AP of claim 4, wherein the Co-BF transmission further comprises transmission, by the second AP to a second STA associated with the second AP, of a second PPDU.

6. The first AP of claim 5, wherein the first PPDU and the second PPDU are concurrent in time.

7. The first AP of claim 1, wherein the Co-BF transmission is scheduled during a transmission opportunity (TXOP) of the first AP.

8. The first AP of claim 1, wherein the first guard interval comprises a duration of 0.8 microseconds, 1.6 microseconds, or 3.2 microseconds.

9. The first AP of claim 1, wherein the third frame comprises a trigger frame.

10. A first access point (AP) comprising:
one or more processors; and
memory storing instructions that, when executed by the one or more processors, cause the first AP to:
receive, from a second AP, a first frame comprising a request to establish a coordinated beamforming (Co-BF) agreement;
transmit, to the second AP and in response to the first frame, a second frame indicating that the first AP supports a first guard interval for the Co-BF agreement;
receive, from the second AP, a third frame indicating the first guard interval for a Co-BF transmission of the Co-BF agreement; and
transmit, to a first STA associated with the first AP and using the first guard interval, a first physical layer protocol data unit (PPDU) for the Co-BF transmission.

11. The first AP of claim 10, wherein the first frame comprises a multi-AP coordination negotiation request frame.

12. The first AP of claim 10, wherein the second frame comprises a multi-AP negotiation response frame.

13. The first AP of claim 10, wherein the Co-BF transmission comprises the transmitting of the first PPDU.

14. The first AP of claim 13, wherein the Co-BF transmission further comprises transmission, by the second AP to a second STA associated with the second AP, of a second PPDU.

15. The first AP of claim 14, wherein the first PPDU and the second PPDU are concurrent in time.

16. The first AP of claim 10, wherein the Co-BF transmission is scheduled during a transmission opportunity (TXOP) of the first AP.

17. The first AP of claim 10, wherein the third frame comprises a trigger frame.

18. A non-transitory computer-readable medium comprising instructions that, when executed by one or more processors of a first access point (AP), cause the first AP to:
transmit, to a second AP, a first frame comprising a request to establish a coordinated beamforming (Co-BF) agreement;
receive, from the second AP and in response to the first frame, a second frame indicating that the second AP supports a first guard interval for the Co-BF agreement;
transmit, to the second AP, a third frame indicating the first guard interval for a Co-BF transmission of the Co-BF agreement; and
transmit, to a first STA associated with the first AP and using the first guard interval, a first physical layer protocol data unit (PPDU) for the Co-BF transmission.

19. The non-transitory computer-readable medium of claim 18, wherein the Co-BF transmission is scheduled during a transmission opportunity (TXOP) of the first AP.

20. The non-transitory computer-readable medium of claim 18, wherein the third frame comprises a trigger frame.
